(19) United States
(12) Patent Application Publication
(10) Pub. No.: US 2024/0323734 A1
(43) Pub. Date: Sep. 26, 2024

(54) CHANNEL MEASUREMENT AND REPORTING IN DISTRIBUTED WIRELESS SYSTEMS

(71) Applicant: QUALCOMM Incorporated, San Diego, CA (US)

(72) Inventors: Hung Dinh LY, San Diego, CA (US); Yu ZHANG, San Diego, CA (US); Hyojin LEE, San Diego, CA (US)

(21) Appl. No.: 18/575,071

(22) PCT Filed: Sep. 1, 2021
(86) PCT No.: PCT/CN2021/115909

§ 371 Date: Dec. 28, 2023

(51) Int. Cl. H04W 24/10

(52) U.S. Cl. CPC H04W 24/10

(57) ABSTRACT

Methods, systems, and devices for wireless communications are described. A user equipment (UE) may receive a control message indicating a joint transmission configuration (e.g., fully coherent, partially coherent, or non-coherent) for a distributed system associated with a base station. The UE may receive reference signals from respective antenna panels of groups of distributed antenna panels. The UE may generate a channel state information (CSI) report based on the joint transmission configuration and the reference signals. In some examples, the UE may receive an indication of a reporting order for parameters in the CSI report, may separately or jointly encode channel state information reference signal resource indicators (CRIs) for the report, may modify a code-book (e.g., a precoder matrix) or cross-group co-phasing coefficients in the CSI report, or any combination thereof. The UE may transmit the CSI report to the base station.

### CROSS REFERENCE

The present Application is a 371 national stage filing of International PCT Application No. PCT/CN2021/115909 by LY et al. entitled “CHANNEL MEASUREMENT AND REPORTING IN DISTRIBUTED WIRELESS SYSTEMS,” filed Sep. 1, 2021, which is assigned to the assignee hereof, and which is expressly incorporated by reference in its entirety herein.

### FIELD OF TECHNOLOGY

The following relates to wireless communications, including channel measurement and reporting in distributed wireless systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, UEs may report channel state information (CSI) feedback to a base station. In some situations, such as for distributed systems, however, the CSI feedback reported by the UE may be inaccurate and traditional techniques for generating CSI feedback for these systems may be deficient.

### SUMMARY

The described techniques relate to improved techniques, devices, and apparatuses that support techniques for channel measurement and reporting in distributed wireless systems. The described techniques may enable a user equipment (UE) to receive a control message indicating a joint transmission configuration (e.g., fully coherent, partially coherent, or non-coherent) for a distributed system associated with a base station. The UE may receive one or more reference signals (e.g., channel state information (CSI) reference signals (CSI-RSs)) from antenna panels of the distributed system, which may include one or more groups of antenna panels associated with or controllable by the base station. The UE may measure the one or more reference signals and generate a report (e.g., a CSI report or other channel measurement report) based on the joint transmission configuration and the one or more reference signals. In some examples, the UE may receive an indication of a reporting order for one or more parameters in the report and the UE may separately or jointly encode CSI-RS resource indicators (CRIs) for the report. In some cases, the UE may modify a codebook (e.g., a precoder matrix), one or more cross-group co-phasing coefficients, or both. Such techniques may improve the accuracy of reporting of CSI or other channel measurements by the UE.

A method for wireless communications at a UE is described. The method may include receiving, from a base station, a control message that indicates a joint transmission configuration for a distributed system associated with the base station, receiving one or more reference signals from respective antenna panels of one or more groups of distributed antenna panels of the distributed system, generating a feedback report indicating one or more CSI parameters for the one or more groups of distributed antenna panels based on the joint transmission configuration and the one or more reference signals, and transmitting the feedback report to the base station.

An apparatus for wireless communications at a UE is described. The apparatus may include a processor, memory coupled with the processor, and instructions stored in the memory. The instructions may be executable by the processor to cause the apparatus to receive, from a base station, a control message that indicates a joint transmission configuration for a distributed system associated with the base station, receive one or more reference signals from respective antenna panels of one or more groups of distributed antenna panels of the distributed system, generate a feedback report indicating one or more CSI parameters for the one or more groups of distributed antenna panels based on the joint transmission configuration and the one or more reference signals, and transmit the feedback report to the base station.

Another apparatus for wireless communications at a UE is described. The apparatus may include means for receiving, from a base station, a control message that indicates a joint transmission configuration for a distributed system associated with the base station, means for receiving one or more reference signals from respective antenna panels of one or more groups of distributed antenna panels of the distributed system, means for generating a feedback report indicating one or more CSI parameters for the one or more groups of distributed antenna panels based on the joint transmission configuration and the one or more reference signals, and means for transmitting the feedback report to the base station.

A non-transitory computer-readable medium storing code for wireless communications at a UE is described. The code may include instructions executable by a processor to receive, from a base station, a control message that indicates a joint transmission configuration for a distributed system associated with the base station, receive one or more reference signals from respective antenna panels of one or more groups of distributed antenna panels of the distributed system, generate a feedback report indicating one or more CSI parameters for the one or more groups of distributed antenna panels based on the joint transmission configuration and the one or more reference signals, and transmit the feedback report to the base station.

In some examples of the method, apparatuses, and non-transitory computer-readable medium described herein, receiving the one or more reference signals may include operations, features, means, or instructions for receiving a first CSI-RS via a first set of resources from a first group of antenna panels of the one or more groups of distributed antenna panels and receiving a second CSI-RS via a second set of resources from a second group of antenna panels of the one or more groups of distributed antenna panels.

In some examples of the method, apparatuses, and non-transitory computer-readable medium described herein, generating the feedback report may include operations, features, means, or instructions for generating a first CSI parameter for the first group of antenna panels based on the first CSI-RS and generating a second CSI parameter for the second group of antenna panels based on the second CSI-RS, where the feedback report includes the first and second CSI parameters according to a reporting order that may be based on the first and second sets of resources.

Some examples of the method, apparatuses, and non-transitory computer-readable medium described herein may further include operations, features, means, or instructions for receiving an indication of the reporting order from the base station, the reporting order configured for the UE.

In some examples of the method, apparatuses, and non-transitory computer-readable medium described herein, the reporting order corresponds to an increasing order or a decreasing order of respective resource identifiers for the first and second sets of resources.

In some examples of the method, apparatuses, and non-transitory computer-readable medium described herein, generating the feedback report may include operations, features, means, or instructions for generating one or more co-phasing coefficients for the feedback report based on the joint transmission configuration indicating a fully coherent configuration or a partially coherent configuration, the one or more co-phasing coefficients for the one or more groups of distributed antenna panels.

In some examples of the method, apparatuses, and non-transitory computer-readable medium described herein, generating the feedback report may include operations, features, means, or instructions for generating one or more CRIs, each of the one or more CRIs corresponding to a respective group of the one or more groups of the distributed antenna panels of the distributed system.

In some examples of the method, apparatuses, and non-transitory computer-readable medium described herein, separately encoding each CRI for each group of the one or more groups of the distributed antenna panels of the distributed system, where the feedback report includes the separately encoded CRI for each group.

In some examples of the method, apparatuses, and non-transitory computer-readable medium described herein, jointly encoding the one or more CRIs for the one or more groups of the distributed antenna panels of the distributed system, where the feedback report includes the jointly encoded one or more CRIs.

In some examples of the method, apparatuses, and non-transitory computer-readable medium described herein, generating the feedback report may include operations, features, means, or instructions for generating one or more co-phasing coefficients for the feedback report, each of the one or more co-phasing coefficients corresponding to a respective group of the one or more groups of the distributed antenna panels of the distributed system, where at least one of the one or more co-phasing coefficients may be zero based on the joint transmission configuration being a partially coherent configuration.

In some examples of the method, apparatuses, and non-transitory computer-readable medium described herein, generating the feedback report may include operations, features, means, or instructions for generating one or more co-phasing coefficients for the feedback report, each of the one or more co-phasing coefficients corresponding to a respective group of the one or more groups of the distributed antenna panels of the distributed system, each group associated with a respective layer of a joint transmission for the UE, where at least one of the one or more co-phasing coefficients may be zero based on the joint transmission configuration being a non-coherent configuration.

In some examples of the method, apparatuses, and non-transitory computer-readable medium described herein, generating the feedback report may include operations, features, means, or instructions for generating a precoder matrix for the feedback report based on the joint transmission configuration being a fully coherent configuration, where each column of the precoder matrix includes at least one non-zero value, the precoder matrix corresponding to a group of the one or more groups of the distributed antenna panels of the distributed system.

In some examples of the method, apparatuses, and non-transitory computer-readable medium described herein, the joint transmission configuration includes one of a fully coherent configuration, a partially coherent configuration, or a non-coherent configuration.

In some examples of the method, apparatuses, and non-transitory computer-readable medium described herein, receiving the control message may include operations, features, means, or instructions for receiving the control message via radio resource control (RRC) signaling, a medium access control (MAC) control element (MAC-CE), or downlink control information (DCI).

A method for wireless communications at a base station is described. The method may include transmitting, to a UE, a control message that indicates a joint transmission configuration for a distributed system associated with the base station, transmitting, to the UE, one or more reference signals using respective antenna panels of one or more groups of distributed antenna panels of the distributed system, and receiving, from the UE, a feedback report indicating one or more CSI parameters for the one or more groups of distributed antenna panels based on the joint transmission configuration and the one or more reference signals.

An apparatus for wireless communications at a base station is described. The apparatus may include a processor, memory coupled with the processor, and instructions stored in the memory. The instructions may be executable by the processor to cause the apparatus to transmit, to a UE, a control message that indicates a joint transmission configuration for a distributed system associated with the base station, transmit, to the UE, one or more reference signals using respective antenna panels of one or more groups of distributed antenna panels of the distributed system, and receive, from the UE, a feedback report indicating one or more CSI parameters for the one or more groups of distributed antenna panels based on the joint transmission configuration and the one or more reference signals.

Another apparatus for wireless communications at a base station is described. The apparatus may include means for transmitting, to a UE, a control message that indicates a joint transmission configuration for a distributed system associated with the base station, means for transmitting, to the UE, one or more reference signals using respective antenna panels of one or more groups of distributed antenna panels of the distributed system, and means for receiving, from the UE, a feedback report indicating one or more CSI parameters for the one or more groups of distributed antenna panels based on the joint transmission configuration and the one or more reference signals.

A non-transitory computer-readable medium storing code for wireless communications at a base station is described. The code may include instructions executable by a processor to transmit, to a UE, a control message that indicates a joint transmission configuration for a distributed system associated with the base station, transmit, to the UE, one or more reference signals using respective antenna panels of one or more groups of distributed antenna panels of the distributed system, and receive, from the UE, a feedback report indicating one or more CSI parameters for the one or more groups of distributed antenna panels based on the joint transmission configuration and the one or more reference signals.

In some examples of the method, apparatuses, and non-transitory computer-readable medium described herein, transmitting the one or more reference signals may include operations, features, means, or instructions for transmitting a first CSI-RS via a first set of resources using a first group of antenna panels of the one or more groups of distributed antenna panels and transmitting a second CSI-RS via a second set of resources using a second group of antenna panels of the one or more groups of distributed antenna panels.

In some examples of the method, apparatuses, and non-transitory computer-readable medium described herein, receiving the feedback report may include operations, features, means, or instructions for receiving a first CSI parameter for the first group of antenna panels based on the first CSI-RS and receiving a second CSI parameter for the second group of antenna panels based on the second CSI-RS, where the feedback report includes the first and second CSI parameters according to a reporting order that may be based on the first and second sets of resources.

Some examples of the method, apparatuses, and non-transitory computer-readable medium described herein may further include operations, features, means, or instructions for transmitting an indication of the reporting order, the reporting order configured for the UE.

In some examples of the method, apparatuses, and non-transitory computer-readable medium described herein, the reporting order corresponds to an increasing order or a decreasing order of respective resource identifiers for the first and second sets of resources.

In some examples of the method, apparatuses, and non-transitory computer-readable medium described herein, receiving the feedback report may include operations, features, means, or instructions for receiving one or more co-phasing coefficients in the feedback report based on the joint transmission configuration indicating a fully coherent configuration or a partially coherent configuration, the one or more co-phasing coefficients for the one or more groups of distributed antenna panels.

In some examples of the method, apparatuses, and non-transitory computer-readable medium described herein, receiving the feedback report may include operations, features, means, or instructions for receiving one or more CRIs, each of the one or more CRIs corresponding to a respective group of the one or more groups of the distributed antenna panels of the distributed system.

In some examples of the method, apparatuses, and non-transitory computer-readable medium described herein, the feedback report includes the separately encoded CRI for each group.

In some examples of the method, apparatuses, and non-transitory computer-readable medium described herein, the feedback report includes the jointly encoded one or more CRIs.

In some examples of the method, apparatuses, and non-transitory computer-readable medium described herein, receiving the feedback report may include operations, features, means, or instructions for receiving one or more co-phasing coefficients in the feedback report, each of the one or more co-phasing coefficients corresponding to a respective group of the one or more groups of the distributed antenna panels of the distributed system, where at least one of the one or more co-phasing coefficients may be zero based on the joint transmission configuration being a partially coherent configuration.

In some examples of the method, apparatuses, and non-transitory computer-readable medium described herein, receiving the feedback report may include operations, features, means, or instructions for receiving one or more co-phasing coefficients in the feedback report, each of the one or more co-phasing coefficients corresponding to a respective group of the one or more groups of the distributed antenna panels of the distributed system, each group associated with a respective layer of a joint transmission for the UE, where at least one of the one or more co-phasing coefficients may be zero based on the joint transmission configuration being a non-coherent configuration.

In some examples of the method, apparatuses, and non-transitory computer-readable medium described herein, receiving the feedback report may include operations, features, means, or instructions for receiving a precoder matrix in the feedback report based on the joint transmission configuration being a fully coherent configuration, where each column of the precoder matrix includes at least one non-zero value, the precoder matrix corresponding to a group of the one or more groups of the distributed antenna panels of the distributed system.

Some examples of the method, apparatuses, and non-transitory computer-readable medium described herein may further include operations, features, means, or instructions for selecting the joint transmission configuration for communicating, using the distributed system associated with the base station, with the UE.

In some examples of the method, apparatuses, and non-transitory computer-readable medium described herein, the joint transmission configuration includes one of a fully coherent configuration, a partially coherent configuration, or a non-coherent configuration.

### BRIEF DESCRIPTION OF THE DRAWINGS

FIG. 1 illustrates an example of a wireless communications system that supports channel measurement and reporting in distributed wireless systems in accordance with aspects of the present disclosure.

FIGS. 2 and 3 illustrate examples of wireless communications systems that support channel measurement and reporting in distributed wireless systems in accordance with aspects of the present disclosure.

FIGS. 4A and 4B illustrates examples of channel state information (CSI) feedback that support channel measurement and reporting in distributed wireless systems in accordance with aspects of the present disclosure.

FIG. 5 illustrates an example of a process flow that supports channel measurement and reporting in distributed wireless systems in accordance with aspects of the present disclosure.

FIGS. 6 and 7 show block diagrams of devices that support channel measurement and reporting in distributed wireless systems in accordance with aspects of the present disclosure.

FIG. 8 shows a block diagram of a communications manager that supports channel measurement and reporting in distributed wireless systems in accordance with aspects of the present disclosure.

FIG. 9 shows a diagram of a system including a device that supports channel measurement and reporting in distributed wireless systems in accordance with aspects of the present disclosure.

FIGS. 10 and 11 show block diagrams of devices that support channel measurement and reporting in distributed wireless systems in accordance with aspects of the present disclosure.

FIG. 12 shows a block diagram of a communications manager that supports channel measurement and reporting in distributed wireless systems in accordance with aspects of the present disclosure.

FIG. 13 shows a diagram of a system including a device that supports channel measurement and reporting in distributed wireless systems in accordance with aspects of the present disclosure.

FIGS. 14 through 17 show flowcharts illustrating methods that support channel measurement and reporting in distributed wireless systems in accordance with aspects of the present disclosure.

### DETAILED DESCRIPTION

In some wireless communications systems, a base station may communicate with one or more wireless devices, such as a user equipment (UE), as part of a distributed system. For example, the base station may use a distributed massive multiple-input multiple-output (MIMO) configuration that supports communication for wireless devices via multiple distributed antenna panels. That is, the base station may communicate with a UE, or other wireless device, using one or more antenna panel groups that may be separated from each other (e.g., the antenna panels may not be co-located) and each antenna panel group may include one or more antenna panels of the multiple distributed antenna panels. The base station may transmit reference signals, such as channel state information (CSI) reference signals (CSI-RSs), to the UE via one or more antenna panel groups, and the UE may measure a channel based on the received reference signals to generate a CSI feedback report for reporting to the base station. However, the UE may be unable to generate accurate CSI feedback for the one or more antenna panel groups without identifying a transmission mode used by base station for transmission of the CSI-RSs.

According to the techniques described herein, the base station may indicate a joint transmission mode to a UE, which may enable the UE to accurately generated and report CSI or other channel measurements in accordance with the indicated joint transmission mode. The joint transmission mode may indicate whether transmissions from the multiple distributed antenna panels are fully coherent (e.g., the base station transmits the same data (e.g., a same data packet or data stream) from each of the one or more antenna panel groups and the UE receives a same data transmission from each antenna panel group), partially coherent (e.g., the base station transmits the same data (e.g., a same data packet or data stream) from some antenna panel groups and other data from other antenna panel groups and the UE receives the same data transmission from some of the antenna panel groups), or non-coherent (e.g., the base station transmits a data transmission from one antenna panel group or different data transmissions from different antenna panel groups and the UE receives different data transmissions from each antenna panel group). The UE may measure or estimate the channel (e.g., the UE may generate one or more channel measurement parameters, such as one or more CSI parameters) and generate a report, such as a CSI feedback report, based on the indication of the joint transmission mode. In some cases, various aspects of the CSI feedback report may differ depending on the indicated joint transmission mode. For example, for fully coherent or partially coherent joint transmissions, the UE may report cross-group co-phasing coefficients. For non-coherent joint transmission, the UE may refrain from reporting or including the cross-group co-phasing coefficients in a report, which may reduce overhead. In some other examples, resource sets for CSI-RSs may differ for each antenna panel group, and the UE may report CSI parameters according to a given order, which may depend on a resource set identifier (ID) of each resource set. In some examples, the UE may report CSI-RS resource indicators (CRIs) for each antenna panel group associated with the base station, and the CRIs may be separately encoded or jointly encoded. In some other examples, a rank-L precoder matrix (e.g., associated with precoding matrix indicators (PMIs) indicated by the CSI report) for different antenna panel groups or the cross-group co-phasing coefficients for different antenna panel groups and layers may vary depending on the joint transmission mode.

Aspects of the disclosure are initially described in the context of wireless communications systems. Aspects of the disclosure are further illustrated by and described with reference to a process flow, apparatus diagrams, system diagrams, and flowcharts that relate to channel measurement and reporting in distributed wireless systems.

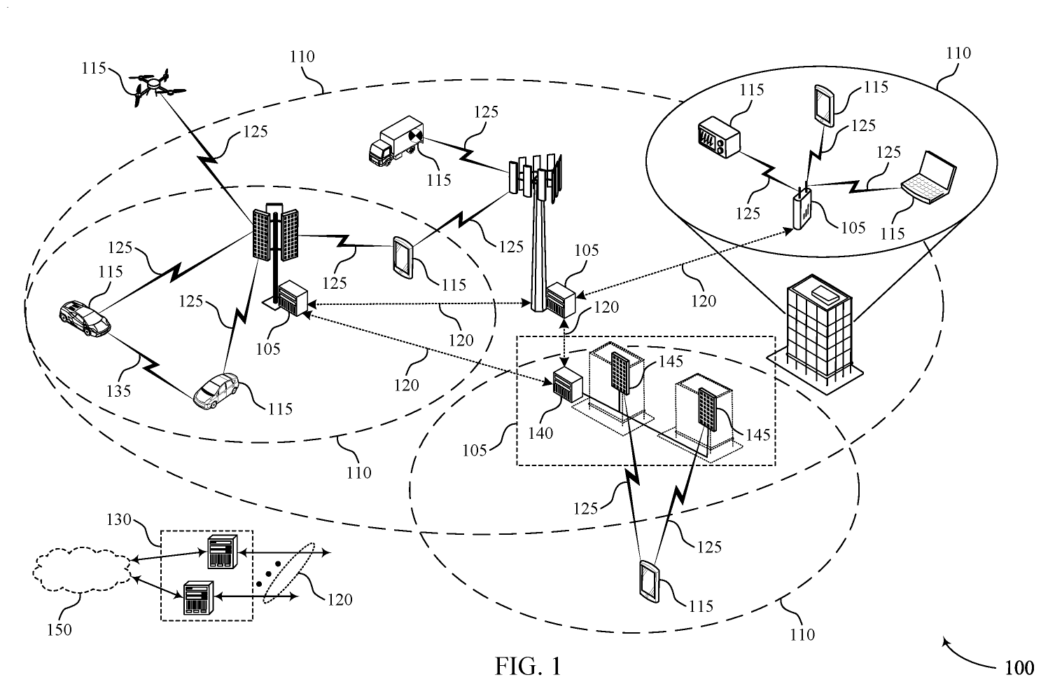

FIG. 1 illustrates an example of a wireless communications system 100 that supports channel measurement and reporting in distributed wireless systems in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical (PHY) layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-RS), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

According to the techniques described herein, a UE 115 may transmit a CSI report based on a configured joint transmission configuration. The UE 115 may receive a control message indicating the joint transmission configuration (e.g., fully coherent, partially coherent, or non-coherent) for a distributed system associated with a base station 105. The UE 115 may receive one or more reference signals from respective antenna panels of one or more groups of multiple distributed antenna panels. The UE 115 may generate the CSI report based on the joint transmission configuration and the one or more reference signals. In some examples, the UE 115 may receive an indication of a reporting order for one or more parameters in the CSI report. In some examples, the UE 115 may separately or jointly encode CRI for the report. In some examples, the UE 115 may modify a codebook (e.g., a precoder matrix), one or more cross-group co-phasing coefficients in the CSI report, or both. The UE 115 may transmit the CSI report to the base station 105. In some examples, the CSI report may include a channel quality indicator (CQI), a PMI, a CRI, a strongest layer indication, a rank indication, a reference signal received power (RSRP) for beam management, or any combination thereof. Higher layer configuration at UE 115 may include N≥1 CSI reporting settings, M≥1 resource settings, L≥1 CSI measurement links, or any combination thereof.

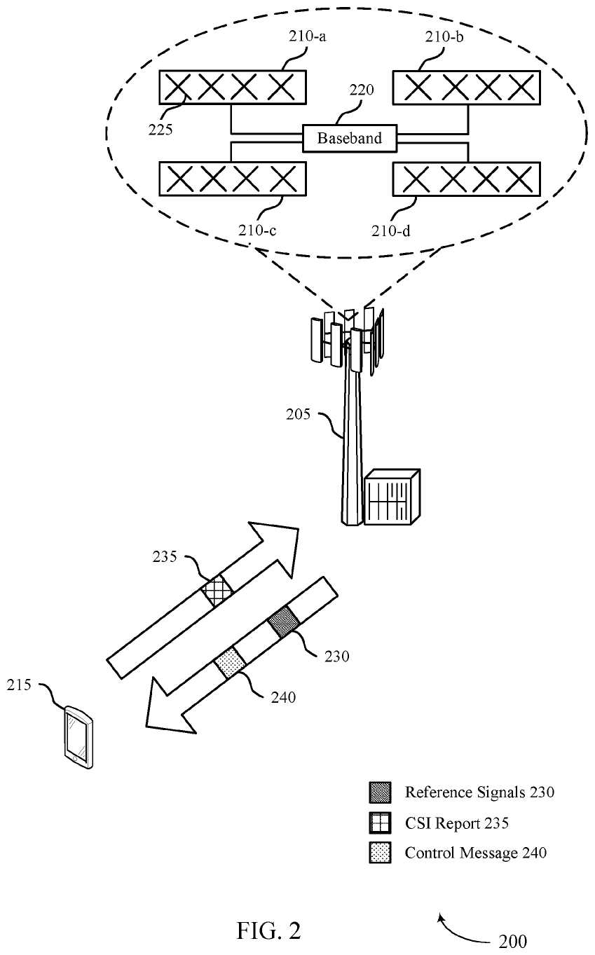

FIG. 2 illustrates an example of a wireless communications system 200 that supports techniques for channel measurement and reporting in distributed wireless systems in accordance with aspects of the present disclosure. The wireless communications system 200 may implement or be implemented by aspects of the wireless communications system 100 as described with reference to FIG. 1. For example, the wireless communications system 200 may include base station 205 and UE 215, which may be examples of base stations 105 and UEs 115 as described herein. The wireless communications system 200 may support improvements to interference, processing, power consumption, and more efficient utilization of communication resources, among other benefits.

A base station 205 may communicate with a UE 215 using a distributed system, such as a distributed massive MIMO system, which may be different from a co-located MIMO system. The distributed massive MIMO system may include one or more antennas or antenna panels 210 that are geometrically distributed in region, associated with the base station 205 (e.g., a cell), and connected to a baseband 220. Each antenna panel 210 may include one or more antenna elements 225. The distributed massive MIMO system may include one or more antenna panel groups, and each antenna panel group may include one or more co-located antenna panels. Some antenna panel groups may include different numbers of antenna panels than other antenna panel groups. In some cases, spacing between antenna panel groups may be relatively large (e.g., spacing between a first antenna panel group including antenna panel 210-a and a second antenna panel group including antenna panel 210-b may be relatively large in comparison to spacing between antenna elements 225, or in comparison to spacing between antenna panels 210 within a given antenna panel group). Some systems (e.g., co-located MIMO systems) may support a 2 dimensional (2D) antenna structure (e.g., planar structure), and multiple antenna panels may be co-located, with no distribution. For some systems (e.g., distributed massive MIMO systems, or co-located massive MIMO systems), spacing between adjacent antennas (e.g., antenna elements 225) may depend on a carrier frequency for communications. For example, a lower carrier frequency may correspond to a larger spacing between antennas. For example, for 1 GHz carrier frequencies or less (e.g., 700 MHZ), a size of a co-located massive MIMO system may be large and impractical to install (e.g., on a rooftop) due to a large form factor of the co-located antenna panels. Distributed massive MIMO systems may thus be beneficial for low frequency communications.

Antenna panels 210 may be locally distributed or fully distributed. Locally distributed panels may include a relatively small inter-panel spacing, and communications using a single PHY layer may be possible. A set of locally distributed panels may be referred to or include a TRP. Fully distributed antenna panels 210 may include a relatively large inter-panel spacing, and may be able to utilize both multi-TRP communication schemes and locally distributed panel communication schemes. UE 215 may be able to communicate with greater than two transmission configuration indicator (TCI) states with base station 205 if antenna panels 210 are fully distributed. In some cases (e.g., for communication configurations or systems that include a type 1 multi-panel codebook, CSI feedback, or both), antenna panels 210 may include a same number of port, a same rank across some or all panels, and orientations of the panels may be the same.

In contrast to distributed massive MIMO systems, some base stations 205 may communicate using a multi-TRP system, which may support communications using two PHY layers. In multi-TRP systems, UEs 215 may be able to communicate with up to two TCI states with base station 205. Thus, in some cases, distributed massive MIMO systems may be beneficial in comparison to multi-TRP systems.

UE 215 in a distributed massive MIMO systems may perform CSI measurement of one or more CSI-RSs (e.g., one or more beams) and may transmit a CSI report to base station 205, which in some cases may enable a coherent joint transmission from base station 205 to UE 215 (e.g., from one or more of the antenna panel groups of antenna panels 210 jointly transmitting to UE 215). Base station 205 may perform resource allocation for the CSI measurement by configuring one or more resource sets (e.g., one or more CSI-RS resources) for the CSI measurement. The number of antenna panel groups of antenna panels 210 may correspond to the number of configured resource sets (e.g., base station 205 may independently configure each resource set for each antenna panel group). Base station 205 (e.g., via one or more of the antenna panel groups) may transmit corresponding reference signals 230 (e.g., CSI-RSs) using the configured resource sets for each antenna panel group, and UE 215 may measure each reference signal 230 from each antenna panel group (e.g., UE 215 may measure one or more beams from each antenna panel group). UE 215 may select a precoder (e.g., W₀, W₁, . . . , W_{K-1}) for groups with a corresponding beam index (e.g., b₀, b₁, . . . , b_{K-1}) by jointly using CSI-RS resources configured for the antenna panel groups. UE 215 may determine co-phase coefficients (e.g., c₀, c₁, . . . , c_{K-1}) for the antenna panel groups, and UE 215 may jointly determine a coefficient c_{K} based on concatenated channels from each of the antenna panel groups. UE 215 may select a beam for each antenna panel group (e.g., corresponding to each CSI-RS for each antenna panel group). UE 215 may jointly derive a CQI based on the selected beams for each antenna panel group, and based on cross-group co-phasing coefficients. UE 215 may then transmit CSI report 235 (e.g., to base station 205, to one or more of the antenna panel groups, to one or more antenna panels 210, or the like), which may include c_{K} (e.g., one or more co-phase coefficients, corresponding to each antenna panel group), b_{K} (e.g., each selected beam for each antenna panel group, that is, b₀, b₁, . . . , b_{K-1}), and the CQI. Providing such CSI feedback to base station 205 may enable the base station 205 or associated antenna panel groups to transmit coherent downlink transmissions. However, in some cases, UE 215 may be unable to accurately generate and report such CSI feedback unless UE 215 identifies a joint transmission configuration for the coherent downlink transmissions.

According to the techniques described herein, base station 205 may transmit control message 240 to configure UE 215 with a joint transmission configuration for the coherent downlink transmissions, and UE 215 may generate and report CSI report 235 based on the indicated joint transmission configuration. In some examples, the joint transmission configuration may be a fully coherent configuration (e.g., base station 205 transmits the same data (e.g., a same data packet or data stream) from each of the one or more antenna panel groups and UE 215 receives a same data transmission from each antenna panel group), a partially coherent configuration (e.g., base station 205 transmits the same data (e.g., a same data packet or data stream) from some antenna panel groups and other data from other antenna panel groups and UE 215 receives the same data transmission from some of the antenna panel groups), or a non-coherent configuration (e.g., base station 205 transmits a data transmission from one antenna panel group or different data transmissions from different antenna panel groups and UE 215 receives different data transmissions from each antenna panel group). In some examples, UE 215 may report CSI parameters (e.g., selected beams, cross-group co-phasing coefficients, and the like) in an order depending on a configured resource set ID for the reference signals 230 (e.g., CSI-RS). In some examples, UE 215 may separately or jointly encode CRI for the CSI report 235. In some examples, UE 215 may report a precoder matrix and one or more cross-group co-phasing coefficients in various ways depending on the joint transmission configuration.

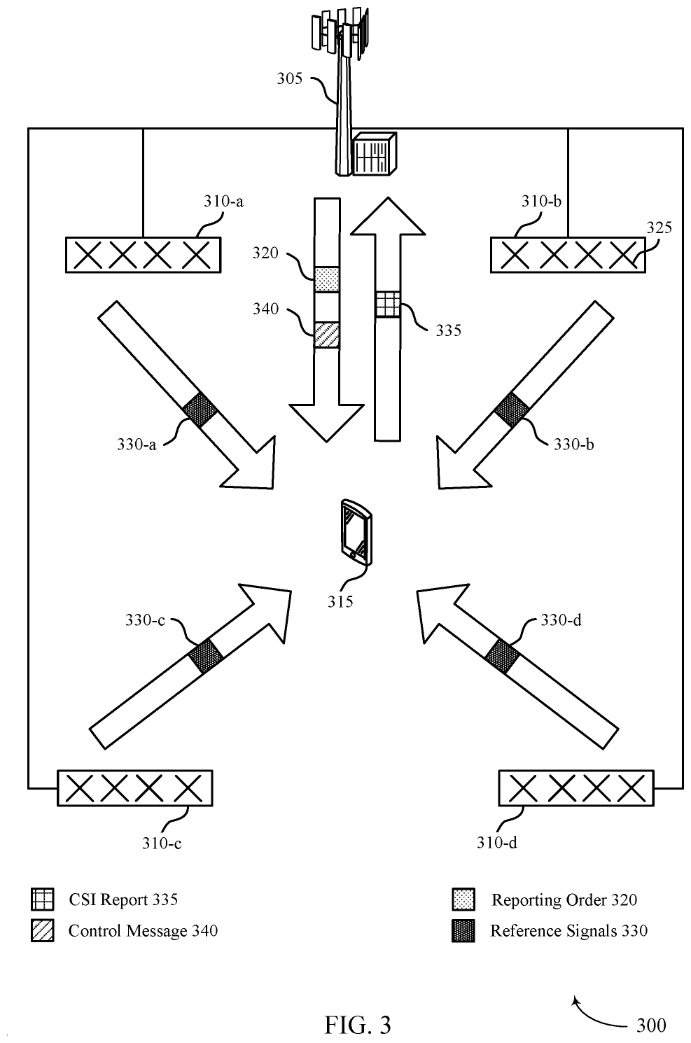

FIG. 3 illustrates an example of a wireless communications system 300 that supports techniques for channel measurement and reporting in distributed wireless systems in accordance with aspects of the present disclosure. The wireless communications system 300 may implement or be implemented by aspects of the wireless communications system 100, wireless communications system 200, or both, as described with reference to FIGS. 1 and 2. For example, the wireless communications system 300 may illustrate sensing and resource selection at a UE, which may be an example of corresponding devices described with reference to FIGS. 1 and 2.

To enable UE 315 to accurately measure reference signals 330 and report CSI feedback, base station 305 may transmit control message 340 to UE 315 indicating a joint transmission configuration for distributed massive MIMO. In some examples, base station 305 may transmit the joint transmission configuration via control message 340 using RRC signaling, a MAC control element (MAC-CE), a downlink control information (DCI) message, or any combination thereof. In some examples, the joint transmission configuration may indicate a fully coherent configuration. Fully coherent configurations may include all antenna panel groups transmitting (e.g., forming) each data layer for a downlink transmission. That is, UE 315 may receive a same transmission from each antenna panel group. In some examples, the joint transmission configuration may indicate a partially coherent configuration. Partially coherent configurations may include a subset of antenna panel groups (e.g., one or more antenna panel groups) transmitting (e.g., forming) each data layer for the downlink transmission. For example, base station 305 may configure a two-layer transmission to the UE, and all antenna panel groups may transmit the first layer of the two-layer transmission, and a subset of antenna panel groups may transmit the second layer of the two-layer transmission. In some other examples, the joint transmission configuration may indicate a non-coherent configuration. Non-coherent configurations may include a single antenna panel group transmitting (e.g., forming) each data layer for the downlink transmission. That is, UE 315 may receive a transmission from a single antenna panel group.

UE 315 may measure one or more CSI-RS reference signals 330, determine one or more parameters for CSI report 335, and report CSI report 335 to base station 305, one or more antenna panel groups (e.g., which may each include one or more antenna panels 310, which may each include one or more antenna elements 325), or any combination thereof. Although FIG. 3 may illustrate UE 315 transmitting CSI report 335 to base station 305, it may be understood that UE 315 may, additionally or alternatively, transmit CSI report 335 to such antenna panel groups as antenna panels 310 may be included in or connected to base station 305. Similarly, UE 315 may receive control message 340 from base station 305, one or more antenna panel groups, or any combination thereof.

UE 315 may include or exclude one or more parameters or other information in CSI report 335 based on the joint transmission configuration indicated in control message 340. For example, for fully or partially coherent joint transmission configurations, UE 315 may include one or more cross-group co-phasing coefficients in CSI report 335. In some other examples, for non-coherent joint transmission configurations, UE 315 may refrain from including the one or more cross-group co-phasing coefficients, which may result in a lower reporting signaling overhead.

UE 315 may report one or more CSI parameters (e.g., selected beams, PMIs, cross-group co-phasing coefficients, and the like) of CSI report 335 in an order (e.g., reporting order 320) depending on a configured resource set ID corresponding to a configured resource set for a CSI-RS reference signal 330, as previously described with reference to FIG. 2. That is, the order may be different for each of the antenna panel groups, as each of the antenna panel groups may correspond to respective resource sets (e.g., different resource sets) for CSI-RS reference signals 330. In some examples, base station 305 may configure the order to UE 315 by transmitting reporting order 320. In some examples, the order may correspond to an increasing order of configured resource set IDs. In some examples, the order may correspond to a decreasing order of configured resource set IDs. For example, for k=4 antenna panel groups (e.g., a first antenna panel group may include antenna panel 310-a, a second antenna panel group may include antenna panel 310-b, a third antenna panel group may include antenna panel 310-c, and a fourth antenna panel group may include antenna panel 310-d), UE 315 may report c₀, c₁, . . . , c_{K-1} and b₀, b₁, . . . , b_{K-1} in this increasing parameter order if UE 315 is configured as such. In some other examples, UE 315 may report c_{K-1}, c_{K-2}, . . . , c₀ and b_{K-1}, b_{K-2}, . . . , b₀ in this decreasing parameter order if UE 315 is configured as such.

In some cases, UE 315 may include one or more CRI (e.g., each CRI corresponding to each antenna panel group) in CSI report 335 to indicate to base station 305 which resource may be selected for joint transmission for a given antenna panel group (e.g., the selected resource may have a desirable or otherwise selected CQI of the calculated CQIs for each resource in the resource set corresponding to a given antenna panel group corresponding to the measured CSI-RS reference signal 330 in the resource set). UE 315 may report separate CRI for each antenna panel group (e.g., CRIₖ, which may indicate that a reported PMI or CQI may depend on which CSI-RS resource of the CSI-RS resource set is selected or associated with the given k-th antenna panel group). That is, CSI report 335 may include four CRIs indicating four resources for each of, for example, four antenna panel groups, each CRI and indicated resource corresponding to an antenna panel group. In some examples, UE 315 may separately encode CRI from the k antenna panel groups. In some examples, UE 315 may jointly encode CRI from the k antenna panel groups. For example, each codepoint may correspond to a predefined combination of CRIs.

In some cases, UE 315 may modify a codebook (e.g., a precoder matrix), one or more cross-group co-phasing coefficients, or both, for CSI report 335 depending on the joint transmission configuration. For example, for the fully coherent joint transmission configuration, UE 315 may modify a precoder matrix Wₙ, where a value of n may correspond to an antenna panel group, to refrain from including an all-zero column. In some examples, for the partially coherent joint transmission configuration, UE 315 may set, for a given layer r, one or more cross-group co-phasing coefficients θₙᵣ=0 for one or more n values (e.g., some, but not all n). In some examples, for the non-coherent joint transmission configuration, UE 315 may set, for a given layer r, θₙᵣ=0 for n≠nᵣ, where n, may be the antenna panel group that transmits or forms the r-th layer.

Precoder matrix Wₙ may be a rank-L, P×L matrix W=[W₀^{T}, W₁^{T}, . . . , W_{K-1}^{T}]^{T} where Wₙ may be a Pₙ×L matrix associated with one or more antenna ports in a CSI-RS resource in the n-th CSI-RS resource set. L may refer to a number of layers for a transmission. In some examples, Wₙ may be defined by Wₙ=diag(θₙ₁, θₙ₂, . . . , θ_{nL}) Wₙ′, where Wₙ′ may be a rank-L precoder from one or more codebooks (e.g., a Type I single panel, or Type II). Our may represent one or more cross-group co-phasing coefficients associated with the n-th antenna panel group and the r-th layer (e.g., where r=1, 2, . . . , L). In some examples, P₀+P₁+ . . . +P_{K-1}=P, where P may be a number of CSI-RS ports.

Based on the accurately received CSI report 335, base station 305 and associated antenna panels 310 may be able to communicate with UE 315.

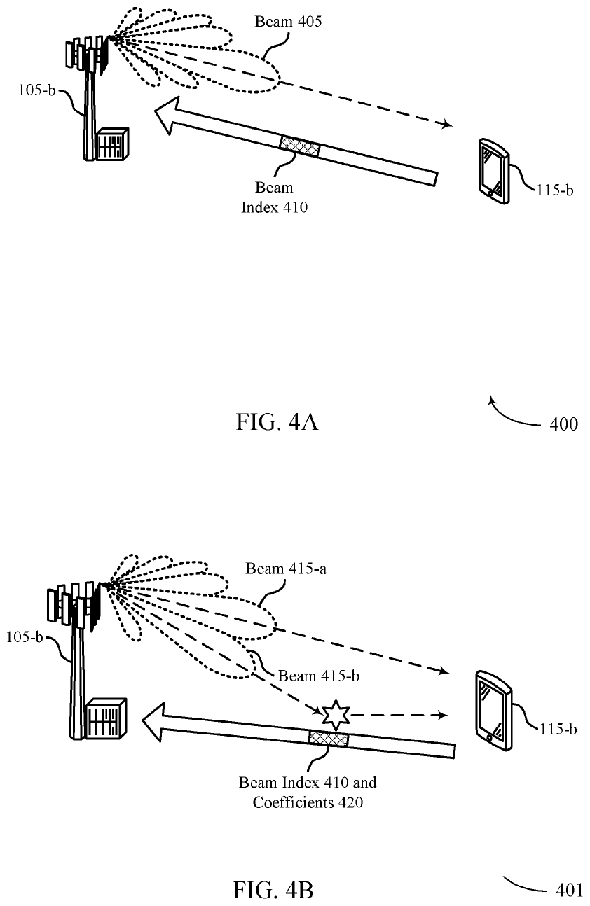

FIGS. 4A and 4B illustrate examples of CSI feedbacks 400 and 401, respectively, that support techniques for channel measurement and reporting in distributed wireless systems in accordance with aspects of the present disclosure. In some examples, CSI feedbacks 400 and 401 may implement aspects of wireless communications systems 100 or 200. CSI feedbacks 400 and 401 may include a base station 105-b and a UE 115-b, which may be examples of corresponding base stations 105 and UEs 115, respectively, as described above with reference to FIGS. 1-3.

CSI feedback 400 may illustrate a Type I CSI feedback transmission by UE 115-b (e.g., based on a Type I precoder). For example, base station 105-b may transmit a downlink signal (e.g., downlink reference transmission) to UE 115-b over multiple candidate beams (e.g., based on oversampled DFT beams). Additionally, base station 105-b may then transmit a trigger for UE 115-b to perform a CSI measurement and transmit a CSI report (e.g., for a single layer). Among the candidate beams, UE 115-b may identify beam 405 as the preferred beam and may transmit a CSI report for beam 405, including a beam index 410 that corresponds to beam 405 (e.g., index of base b₁). The CSI report for CSI feedback 400 (e.g., Type I) may have a lower resolution, but also have a smaller payload. In some cases, UE 115-b may determine a precoding vector for an l-th layer given by matrix Wₗ:

$${W}_{l} = [ \begin{matrix}b \\ Φ \times b\end{matrix} ]$$

where b may represent an oversampled DFT beam and ϕ may represent a cross-pol co-phasing parameter. In some cases, b may be at +45 degrees, and ϕ×b may be at −45 degrees.

CSI feedback 401 may illustrate a Type II CSI feedback transmission by UE 115-b (e.g., based on a Type II precoder). For example, base station 105-b may transmit a downlink signal (e.g., downlink reference transmission) to UE 115-b over multiple candidate beams (e.g., based on oversampled DFT beams). Additionally, base station 105-b may then transmit a trigger for UE 115-b to perform a CSI measurement and transmit a CSI report (e.g., for multiple layers). Among the candidate beams, UE 115-b may identify beams 415-a and 415-b as the preferred beams and may transmit a CSI report for beams 415-a and 415-b together (e.g., multiple layers), including a beam index 410 that corresponds to beams 415-a and 415-b (e.g., indices of basis b₁ and b₂) and coefficients 420 for each beam (e.g., coefficients c₁ and c₂ for beams 415-a and 415-b, respectively). In some cases, the CSI report for CSI feedback 401 (e.g., Type II) may have a higher resolution, but also have a larger payload (e.g., compared to CSI feedback 400). In some cases, UE 115-b may determine a precoding vector for an l-th layer given by matrix Wₗ:

$${W}_{l} = {\sum }_{i = 0}^{L - 1} ( \begin{matrix}{p}_{+ , l , i}^{( W B )} \times {p}_{+ , l , i}^{( S B )} \times {c}_{+ , l , i} \times {b}_{i} \\ {p}_{- , l , i}^{( W B )} \times {p}_{- , l , i}^{( S B )} \times {c}_{- , l , i} \times {b}_{i}\end{matrix} )$$

where p_{+,l,i}^{(WB)} and p_{-,l,i}^{(WB)} may represent wideband amplifiers, p_{+,l,i}^{(SB)} and p_{-,l,i}^{(SB)} may represent subband amplifiers, c_{+,l,i} and c_{-,l,i} may represent a subband phase, and bᵢ may represent L orthogonal DFT basis {b₀, b₁, . . . , b_{L-1}}. In this equation, Wₗ may be calculate per layer/pol/beam coefficient.

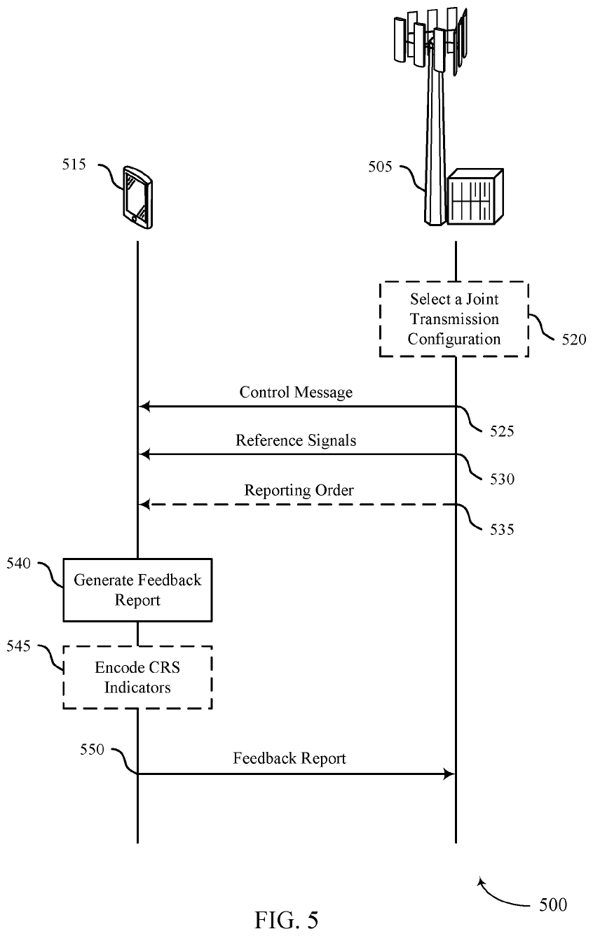

FIG. 5 illustrates an example of a process flow 500 that supports techniques for channel measurement and reporting in distributed wireless systems in accordance with aspects of the present disclosure. The process flow 500 may implement or be implemented by aspects of the wireless communications system 100, wireless communications system 200, wireless communications system 300, CSI feedbacks 400 and 401, or a combination of these, as described with reference to FIGS. 1-4. In some examples, the process flow 500 may include example operations associated with UE 515 and base station 505, which may be examples of corresponding devices described with reference to FIGS. 1-4. In the following description of the process flow 500, the operations between the UE 515 and base station 505 may be performed in a different order than the example order shown, or the operations performed by UE 515 and base station 505 may be performed in different orders or at different times. Some operations may also be omitted from the process flow 500, and other operations may be added to the process flow 500.

At 520, base station 505 may select a joint transmission configuration for communicating, using a distributed system associated with base station 505, with UE 515. In some cases, the joint transmission configuration may include one of a fully coherent configuration, a partially coherent configuration, or a non-coherent configuration.

At 525, UE 515 may receive, from base station 505, a control message that indicates the joint transmission configuration for the distributed system associated with base station 505. In some cases, UE 515 may receive the control message via RRC signaling, a MAC-CE, or DCI.

At 530, UE 515 may receive one or more reference signals from respective antenna panels of one or more groups of distributed antenna panels of the distributed system. In some cases, UE 515 may receive a first CSI-RS via a first set of resources from a first group of antenna panels of the one or more groups of distributed antenna panels, and may receive a second CSI-RS via a second set of resources from a second group of antenna panels of the one or more groups of distributed antenna panels.

At 535, UE 515 may receive an indication of a reporting order from base station 505, the reporting order configured for UE 515.

At 540, UE 515 may generate a feedback report indicating one or more CSI parameters for the one or more groups of distributed antenna panels based on the joint transmission configuration and the one or more reference signals. In some cases, UE 515 may generate a first CSI parameter for the first group of antenna panels based on the first CSI-RS, and may generate a second CSI parameter for the second group of antenna panels based on the second CSI-RS, where the feedback report includes the first and second CSI parameters according to a reporting order that may be based on the first and second sets of resources. In some cases, the reporting order may correspond to an increasing order or a decreasing order of respective resource IDs for the first and second sets of resources. In some cases, UE 515 may generate one or more co-phasing coefficients for the feedback report based on the joint transmission configuration indicating a fully coherent configuration or a partially coherent configuration, the one or more co-phasing coefficients for the one or more groups of distributed antenna panels.

In some cases, UE 515 may generate a second one or more co-phasing coefficients for the feedback report, each of the second one or more co-phasing coefficients corresponding to a respective group of the one or more groups of the distributed antenna panels of the distributed system, where at least one of the one or more co-phasing coefficients may be zero based on the joint transmission configuration being a partially coherent configuration. In some cases, UE 515 may generate a third one or more co-phasing coefficients for the feedback report, each of the third one or more co-phasing coefficients corresponding to a respective group of the one or more groups of the distributed antenna panels of the distributed system, each group associated with a respective layer of a joint transmission for UE 515, where at least one of the one or more co-phasing coefficients may be zero based on the joint transmission configuration being a non-coherent configuration. In some cases, UE 515 may generate a precoder matrix for the feedback report based on the joint transmission configuration being a fully coherent configuration, where each column of the precoder matrix may include at least one non-zero value, the precoder matrix corresponding to a group of the one or more groups of the distributed antenna panels of the distributed system.

At 545, UE 515 may generate one or more CRIs, each of the one or more CRIs corresponding to a respective group of the one or more groups of the distributed antenna panels of the distributed system. In some cases, UE 515 may separately encode each CRI for each group of the one or more groups of the distributed antenna panels of the distributed system, where the feedback report may include the separately encoded CRI for each group. In some cases, UE 515 may jointly encode the one or more CRIs for the one or more groups of the distributed antenna panels of the distributed system, where the feedback report may include the jointly encoded one or more CRI.

At 550, UE 515 may transmit the feedback report to base station 505.

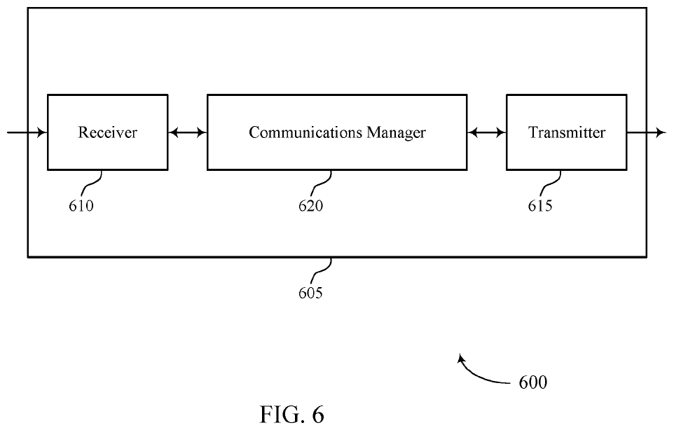

FIG. 6 shows a block diagram 600 of a device 605 that supports channel measurement and reporting in distributed wireless systems in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to channel measurement and reporting in distributed wireless systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to channel measurement and reporting in distributed wireless systems). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of channel measurement and reporting in distributed wireless systems as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving, from a base station, a control message that indicates a joint transmission configuration for a distributed system associated with the base station. The communications manager 620 may be configured as or otherwise support a means for receiving one or more reference signals from respective antenna panels of one or more groups of distributed antenna panels of the distributed system. The communications manager 620 may be configured as or otherwise support a means for generating a feedback report indicating one or more CSI parameters for the one or more groups of distributed antenna panels based on the joint transmission configuration and the one or more reference signals. The communications manager 620 may be configured as or otherwise support a means for transmitting the feedback report to the base station.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for reduced processing, reduced power consumption, and more efficient utilization of communication resources.

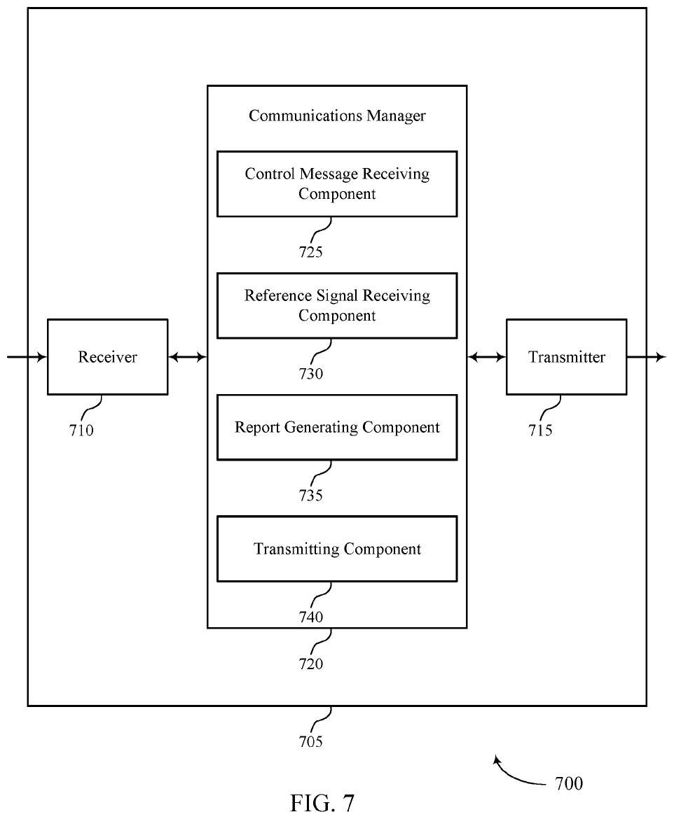

FIG. 7 shows a block diagram 700 of a device 705 that supports channel measurement and reporting in distributed wireless systems in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to channel measurement and reporting in distributed wireless systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to channel measurement and reporting in distributed wireless systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of channel measurement and reporting in distributed wireless systems as described herein. For example, the communications manager 720 may include a control message receiving component 725, a reference signal receiving component 730, a report generating component 735, a transmitting component 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The control message receiving component 725 may be configured as or otherwise support a means for receiving, from a base station, a control message that indicates a joint transmission configuration for a distributed system associated with the base station. The reference signal receiving component 730 may be configured as or otherwise support a means for receiving one or more reference signals from respective antenna panels of one or more groups of distributed antenna panels of the distributed system. The report generating component 735 may be configured as or otherwise support a means for generating a feedback report indicating one or more CSI parameters for the one or more groups of distributed antenna panels based on the joint transmission configuration and the one or more reference signals. The transmitting component 740 may be configured as or otherwise support a means for transmitting the feedback report to the base station.

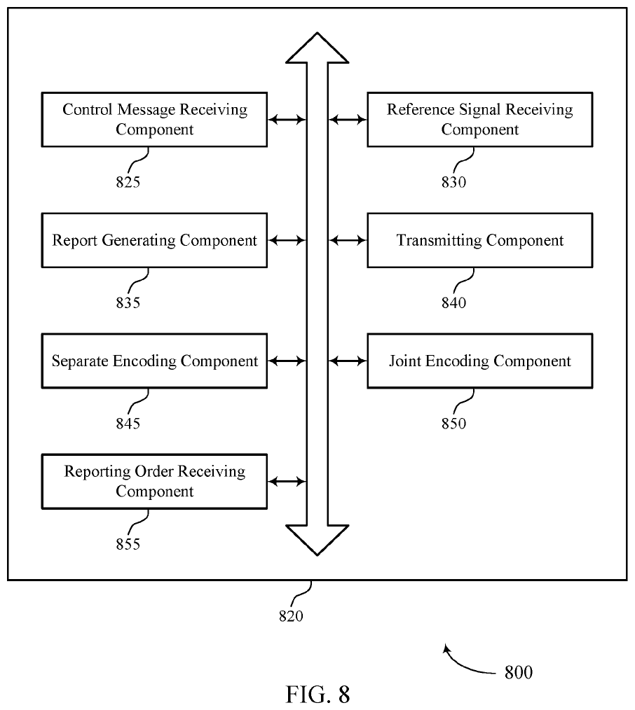

FIG. 8 shows a block diagram 800 of a communications manager 820 that supports channel measurement and reporting in distributed wireless systems in accordance with aspects of the present disclosure. The communications manager 820 may be an example of aspects of a communications manager 620, a communications manager 720, or both, as described herein. The communications manager 820, or various components thereof, may be an example of means for performing various aspects of channel measurement and reporting in distributed wireless systems as described herein. For example, the communications manager 820 may include a control message receiving component 825, a reference signal receiving component 830, a report generating component 835, a transmitting component 840, a separate encoding component 845, a joint encoding component 850, a reporting order receiving component 855, or any combination thereof. Each of these components may communicate, directly or indirectly, with one another (e.g., via one or more buses).

The communications manager 820 may support wireless communications at a UE in accordance with examples as disclosed herein. The control message receiving component 825 may be configured as or otherwise support a means for receiving, from a base station, a control message that indicates a joint transmission configuration for a distributed system associated with the base station. The reference signal receiving component 830 may be configured as or otherwise support a means for receiving one or more reference signals from respective antenna panels of one or more groups of distributed antenna panels of the distributed system. The report generating component 835 may be configured as or otherwise support a means for generating a feedback report indicating one or more CSI parameters for the one or more groups of distributed antenna panels based on the joint transmission configuration and the one or more reference signals. The transmitting component 840 may be configured as or otherwise support a means for transmitting the feedback report to the base station.

In some examples, to support receiving the one or more reference signals, the reference signal receiving component 830 may be configured as or otherwise support a means for receiving a first CSI-RS via a first set of resources from a first group of antenna panels of the one or more groups of distributed antenna panels. In some examples, to support receiving the one or more reference signals, the reference signal receiving component 830 may be configured as or otherwise support a means for receiving a second CSI-RS via a second set of resources from a second group of antenna panels of the one or more groups of distributed antenna panels.

In some examples, to support generating the feedback report, the report generating component 835 may be configured as or otherwise support a means for generating a first CSI parameter for the first group of antenna panels based on the first CSI-RS. In some examples, to support generating the feedback report, the report generating component 835 may be configured as or otherwise support a means for generating a second CSI parameter for the second group of antenna panels based on the second CSI-RS, where the feedback report includes the first and second CSI parameters according to a reporting order that is based on the first and second sets of resources.

In some examples, the reporting order receiving component 855 may be configured as or otherwise support a means for receiving an indication of the reporting order from the base station, the reporting order configured for the UE.

In some examples, the reporting order corresponds to an increasing order or a decreasing order of respective resource identifiers for the first and second sets of resources.

In some examples, to support generating the feedback report, the report generating component 835 may be configured as or otherwise support a means for generating one or more co-phasing coefficients for the feedback report based on the joint transmission configuration indicating a fully coherent configuration or a partially coherent configuration, the one or more co-phasing coefficients for the one or more groups of distributed antenna panels.

In some examples, to support generating the feedback report, the report generating component 835 may be configured as or otherwise support a means for generating one or more CSI-RS resource indicators, each of the one or more CSI-RS resource indicators corresponding to a respective group of the one or more groups of the distributed antenna panels of the distributed system.

In some examples, the separate encoding component 845 may be configured as or otherwise support a means for separately encoding each CSI-RS resource indicator for each group of the one or more groups of the distributed antenna panels of the distributed system, where the feedback report includes the separately encoded CSI-RS resource indicator for each group.

In some examples, the joint encoding component 850 may be configured as or otherwise support a means for jointly encoding the one or more CSI-RS resource indicators for the one or more groups of the distributed antenna panels of the distributed system, where the feedback report includes the jointly encoded one or more CSI-RS resource indicators.

In some examples, to support generating the feedback report, the report generating component 835 may be configured as or otherwise support a means for generating one or more co-phasing coefficients for the feedback report, each of the one or more co-phasing coefficients corresponding to a respective group of the one or more groups of the distributed antenna panels of the distributed system, where at least one of the one or more co-phasing coefficients is zero based on the joint transmission configuration being a partially coherent configuration.

In some examples, to support generating the feedback report, the report generating component 835 may be configured as or otherwise support a means for generating one or more co-phasing coefficients for the feedback report, each of the one or more co-phasing coefficients corresponding to a respective group of the one or more groups of the distributed antenna panels of the distributed system, each group associated with a respective layer of a joint transmission for the UE, where at least one of the one or more co-phasing coefficients is zero based on the joint transmission configuration being a non-coherent configuration.

In some examples, to support generating the feedback report, the report generating component 835 may be configured as or otherwise support a means for generating a precoder matrix for the feedback report based on the joint transmission configuration being a fully coherent configuration, where each column of the precoder matrix includes at least one non-zero value, the precoder matrix corresponding to a group of the one or more groups of the distributed antenna panels of the distributed system.

In some examples, the joint transmission configuration includes one of a fully coherent configuration, a partially coherent configuration, or a non-coherent configuration.

In some examples, to support receiving the control message, the control message receiving component 825 may be configured as or otherwise support a means for receiving the control message via RRC signaling, a MAC-CE, or DCI.

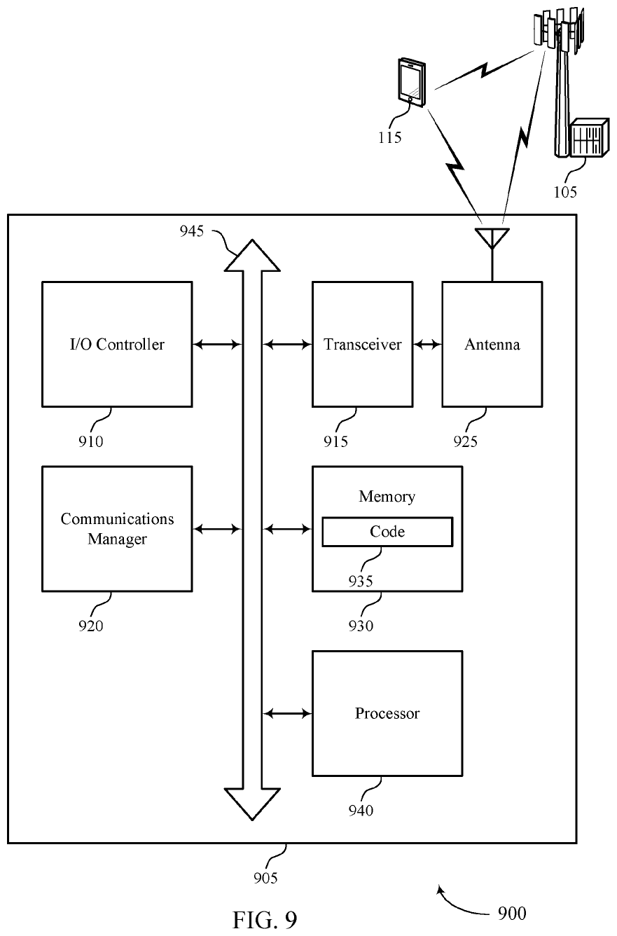

FIG. 9 shows a diagram of a system 900 including a device 905 that supports channel measurement and reporting in distributed wireless systems in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting channel measurement and reporting in distributed wireless systems). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a base station, a control message that indicates a joint transmission configuration for a distributed system associated with the base station. The communications manager 920 may be configured as or otherwise support a means for receiving one or more reference signals from respective antenna panels of one or more groups of distributed antenna panels of the distributed system. The communications manager 920 may be configured as or otherwise support a means for generating a feedback report indicating one or more CSI parameters for the one or more groups of distributed antenna panels based on the joint transmission configuration and the one or more reference signals. The communications manager 920 may be configured as or otherwise support a means for transmitting the feedback report to the base station.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of channel measurement and reporting in distributed wireless systems as described herein, or the processor 940 and the memory 930 may be otherwise configured to perform or support such operations.

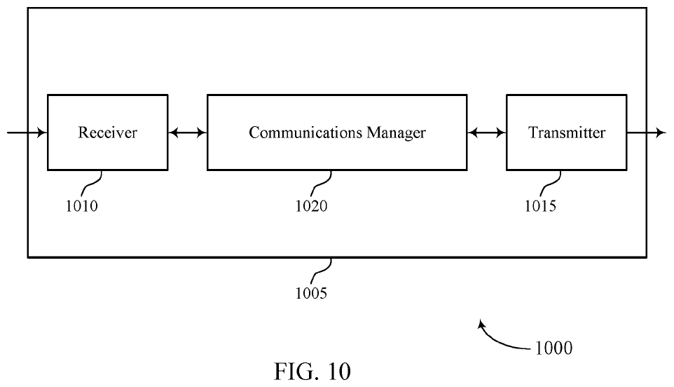

FIG. 10 shows a block diagram 1000 of a device 1005 that supports channel measurement and reporting in distributed wireless systems in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to channel measurement and reporting in distributed wireless systems). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to channel measurement and reporting in distributed wireless systems). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of channel measurement and reporting in distributed wireless systems as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, a control message that indicates a joint transmission configuration for a distributed system associated with the base station. The communications manager 1020 may be configured as or otherwise support a means for transmitting, to the UE, one or more reference signals using respective antenna panels of one or more groups of distributed antenna panels of the distributed system. The communications manager 1020 may be configured as or otherwise support a means for receiving, from the UE, a feedback report indicating one or more CSI parameters for the one or more groups of distributed antenna panels based on the joint transmission configuration and the one or more reference signals.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for reduced processing, reduced power consumption, and more efficient utilization of communication resources.

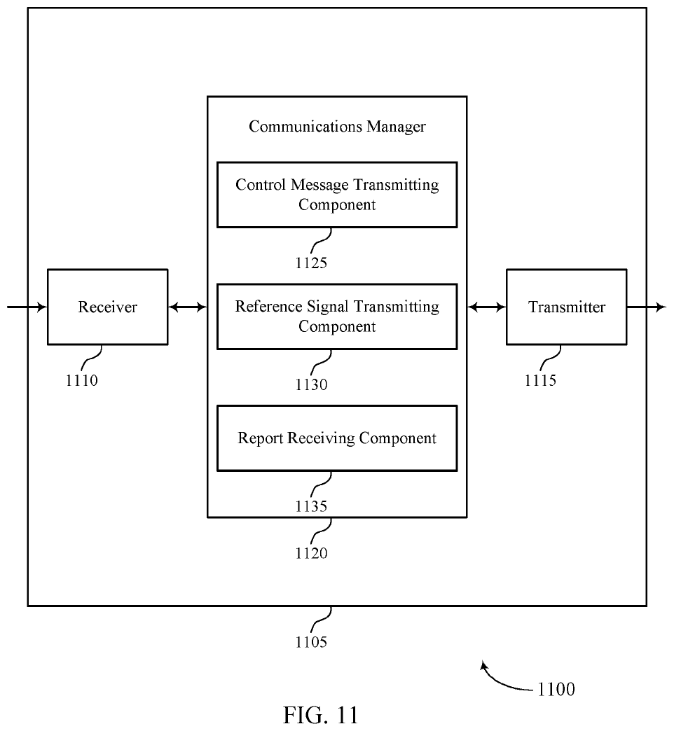

FIG. 11 shows a block diagram 1100 of a device 1105 that supports channel measurement and reporting in distributed wireless systems in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to channel measurement and reporting in distributed wireless systems). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to channel measurement and reporting in distributed wireless systems). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of channel measurement and reporting in distributed wireless systems as described herein. For example, the communications manager 1120 may include a control message transmitting component 1125, a reference signal transmitting component 1130, a report receiving component 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The control message transmitting component 1125 may be configured as or otherwise support a means for transmitting, to a UE, a control message that indicates a joint transmission configuration for a distributed system associated with the base station. The reference signal transmitting component 1130 may be configured as or otherwise support a means for transmitting, to the UE, one or more reference signals using respective antenna panels of one or more groups of distributed antenna panels of the distributed system. The report receiving component 1135 may be configured as or otherwise support a means for receiving, from the UE, a feedback report indicating one or more CSI parameters for the one or more groups of distributed antenna panels based on the joint transmission configuration and the one or more reference signals.

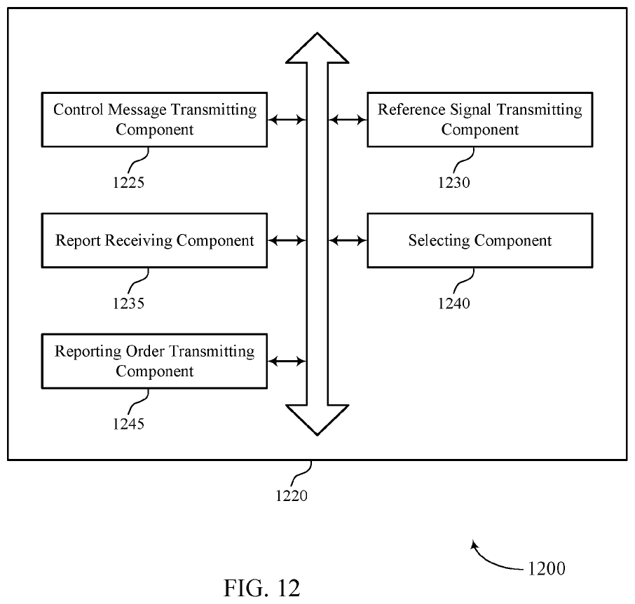

FIG. 12 shows a block diagram 1200 of a communications manager 1220 that supports channel measurement and reporting in distributed wireless systems in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of channel measurement and reporting in distributed wireless systems as described herein. For example, the communications manager 1220 may include a control message transmitting component 1225, a reference signal transmitting component 1230, a report receiving component 1235, a selecting component 1240, a reporting order transmitting component 1245, or any combination thereof. Each of these components may communicate, directly or indirectly, with one another (e.g., via one or more buses).

The communications manager 1220 may support wireless communications at a base station in accordance with examples as disclosed herein. The control message transmitting component 1225 may be configured as or otherwise support a means for transmitting, to a UE, a control message that indicates a joint transmission configuration for a distributed system associated with the base station. The reference signal transmitting component 1230 may be configured as or otherwise support a means for transmitting, to the UE, one or more reference signals using respective antenna panels of one or more groups of distributed antenna panels of the distributed system. The report receiving component 1235 may be configured as or otherwise support a means for receiving, from the UE, a feedback report indicating one or more CSI parameters for the one or more groups of distributed antenna panels based on the joint transmission configuration and the one or more reference signals.

In some examples, to support transmitting the one or more reference signals, the reference signal transmitting component 1230 may be configured as or otherwise support a means for transmitting a first CSI-RS via a first set of resources using a first group of antenna panels of the one or more groups of distributed antenna panels. In some examples, to support transmitting the one or more reference signals, the reference signal transmitting component 1230 may be configured as or otherwise support a means for transmitting a second CSI-RS via a second set of resources using a second group of antenna panels of the one or more groups of distributed antenna panels.

In some examples, to support receiving the feedback report, the report receiving component 1235 may be configured as or otherwise support a means for receiving a first CSI parameter for the first group of antenna panels based on the first CSI-RS. In some examples, to support receiving the feedback report, the report receiving component 1235 may be configured as or otherwise support a means for receiving a second CSI parameter for the second group of antenna panels based on the second CSI-RS, where the feedback report includes the first and second CSI parameters according to a reporting order that is based on the first and second sets of resources.

In some examples, the reporting order transmitting component 1245 may be configured as or otherwise support a means for transmitting an indication of the reporting order, the reporting order configured for the UE.

In some examples, the reporting order corresponds to an increasing order or a decreasing order of respective resource identifiers for the first and second sets of resources.

In some examples, to support receiving the feedback report, the report receiving component 1235 may be configured as or otherwise support a means for receiving one or more co-phasing coefficients in the feedback report based on the joint transmission configuration indicating a fully coherent configuration or a partially coherent configuration, the one or more co-phasing coefficients for the one or more groups of distributed antenna panels.

In some examples, to support receiving the feedback report, the report receiving component 1235 may be configured as or otherwise support a means for receiving one or more CSI-RS resource indicators, each of the one or more CSI-RS resource indicators corresponding to a respective group of the one or more groups of the distributed antenna panels of the distributed system.

In some examples, the feedback report includes the separately encoded CSI-RS resource indicator for each group.

In some examples, the feedback report includes the jointly encoded one or more CSI-RS resource indicators.

In some examples, to support receiving the feedback report, the report receiving component 1235 may be configured as or otherwise support a means for receiving one or more co-phasing coefficients in the feedback report, each of the one or more co-phasing coefficients corresponding to a respective group of the one or more groups of the distributed antenna panels of the distributed system, where at least one of the one or more co-phasing coefficients is zero based on the joint transmission configuration being a partially coherent configuration.

In some examples, to support receiving the feedback report, the report receiving component 1235 may be configured as or otherwise support a means for receiving one or more co-phasing coefficients in the feedback report, each of the one or more co-phasing coefficients corresponding to a respective group of the one or more groups of the distributed antenna panels of the distributed system, each group associated with a respective layer of a joint transmission for the UE, where at least one of the one or more co-phasing coefficients is zero based on the joint transmission configuration being a non-coherent configuration.

In some examples, to support receiving the feedback report, the report receiving component 1235 may be configured as or otherwise support a means for receiving a precoder matrix in the feedback report based on the joint transmission configuration being a fully coherent configuration, where each column of the precoder matrix includes at least one non-zero value, the precoder matrix corresponding to a group of the one or more groups of the distributed antenna panels of the distributed system.

In some examples, the selecting component 1240 may be configured as or otherwise support a means for selecting the joint transmission configuration for communicating, using the distributed system associated with the base station, with the UE.

In some examples, the joint transmission configuration includes one of a fully coherent configuration, a partially coherent configuration, or a non-coherent configuration.

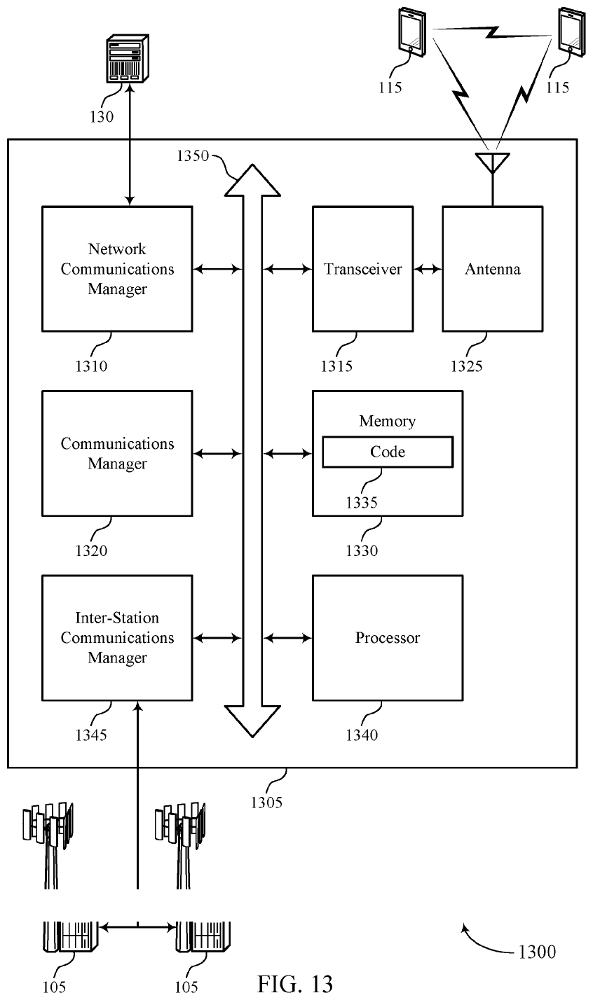

FIG. 13 shows a diagram of a system 1300 including a device 1305 that supports channel measurement and reporting in distributed wireless systems in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting channel measurement and reporting in distributed wireless systems). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, a control message that indicates a joint transmission configuration for a distributed system associated with the base station. The communications manager 1320 may be configured as or otherwise support a means for transmitting, to the UE, one or more reference signals using respective antenna panels of one or more groups of distributed antenna panels of the distributed system. The communications manager 1320 may be configured as or otherwise support a means for receiving, from the UE, a feedback report indicating one or more CSI parameters for the one or more groups of distributed antenna panels based on the joint transmission configuration and the one or more reference signals.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of channel measurement and reporting in distributed wireless systems as described herein, or the processor 1340 and the memory 1330 may be otherwise configured to perform or support such operations.

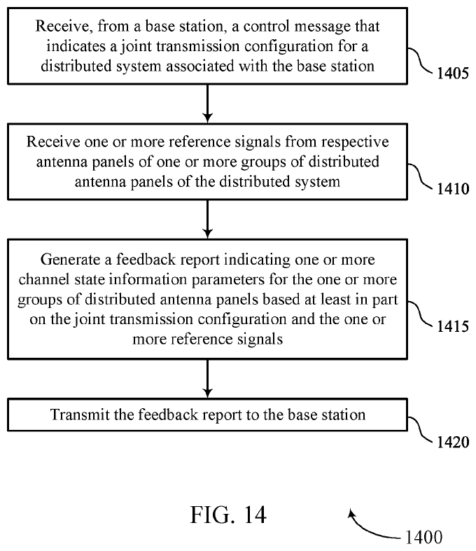

FIG. 14 shows a flowchart illustrating a method 1400 that supports channel measurement and reporting in distributed wireless systems in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a control message that indicates a joint transmission configuration for a distributed system associated with the base station. The operations of 1405 may be performed in accordance with examples as disclosed herein. In some examples, aspects of the operations of 1405 may be performed by a control message receiving component 825 as described with reference to FIG. 8.

At 1410, the method may include receiving one or more reference signals from respective antenna panels of one or more groups of distributed antenna panels of the distributed system. The operations of 1410 may be performed in accordance with examples as disclosed herein. In some examples, aspects of the operations of 1410 may be performed by a reference signal receiving component 830 as described with reference to FIG. 8.

At 1415, the method may include generating a feedback report indicating one or more CSI parameters for the one or more groups of distributed antenna panels based on the joint transmission configuration and the one or more reference signals. The operations of 1415 may be performed in accordance with examples as disclosed herein. In some examples, aspects of the operations of 1415 may be performed by a report generating component 835 as described with reference to FIG. 8.

At 1420, the method may include transmitting the feedback report to the base station. The operations of 1420 may be performed in accordance with examples as disclosed herein. In some examples, aspects of the operations of 1420 may be performed by a transmitting component 840 as described with reference to FIG. 8.

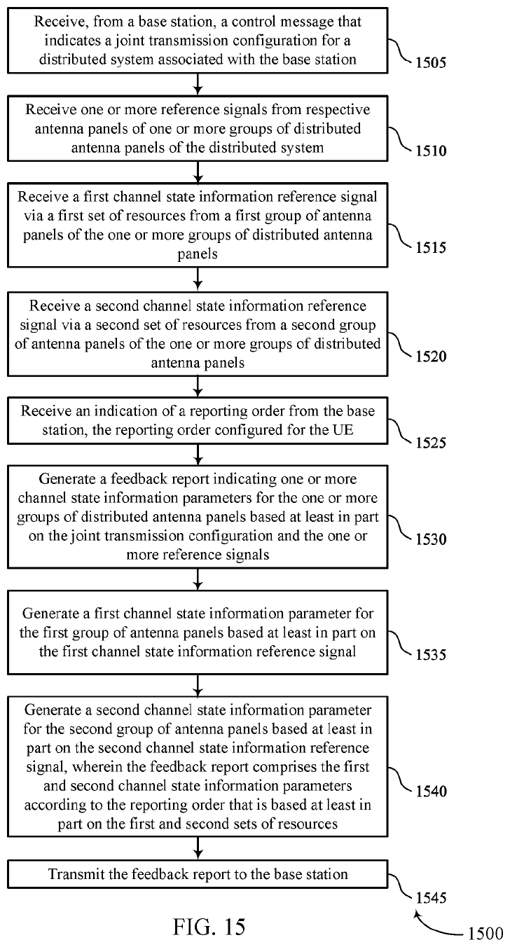

FIG. 15 shows a flowchart illustrating a method 1500 that supports channel measurement and reporting in distributed wireless systems in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a control message that indicates a joint transmission configuration for a distributed system associated with the base station. The operations of 1505 may be performed in accordance with examples as disclosed herein. In some examples, aspects of the operations of 1505 may be performed by a control message receiving component 825 as described with reference to FIG. 8.

At 1510, the method may include receiving one or more reference signals from respective antenna panels of one or more groups of distributed antenna panels of the distributed system. The operations of 1510 may be performed in accordance with examples as disclosed herein. In some examples, aspects of the operations of 1510 may be performed by a reference signal receiving component 830 as described with reference to FIG. 8.

At 1515, the method may include receiving a first CSI-RS via a first set of resources from a first group of antenna panels of the one or more groups of distributed antenna panels. The operations of 1515 may be performed in accordance with examples as disclosed herein. In some examples, aspects of the operations of 1515 may be performed by a reference signal receiving component 830 as described with reference to FIG. 8.

At 1520, the method may include receiving a second CSI-RS via a second set of resources from a second group of antenna panels of the one or more groups of distributed antenna panels. The operations of 1520 may be performed in accordance with examples as disclosed herein. In some examples, aspects of the operations of 1520 may be performed by a reference signal receiving component 830 as described with reference to FIG. 8.

At 1525, the method may include receiving an indication of a reporting order from the base station, the reporting order configured for the UE. The operations of 1525 may be performed in accordance with examples as disclosed herein. In some examples, aspects of the operations of 1525 may be performed by a reporting order receiving component 855 as described with reference to FIG. 8.

At 1530, the method may include generating a feedback report indicating one or more CSI parameters for the one or more groups of distributed antenna panels based on the joint transmission configuration and the one or more reference signals. The operations of 1530 may be performed in accordance with examples as disclosed herein. In some examples, aspects of the operations of 1530 may be performed by a report generating component 835 as described with reference to FIG. 8.

At 1535, the method may include generating a first CSI parameter for the first group of antenna panels based on the first CSI-RS. The operations of 1535 may be performed in accordance with examples as disclosed herein. In some examples, aspects of the operations of 1535 may be performed by a report generating component 835 as described with reference to FIG. 8.

At 1540, the method may include generating a second CSI parameter for the second group of antenna panels based on the second CSI-RS, where the feedback report includes the first and second CSI parameters according to the reporting order that is based on the first and second sets of resources. The operations of 1540 may be performed in accordance with examples as disclosed herein. In some examples, aspects of the operations of 1540 may be performed by a report generating component 835 as described with reference to FIG. 8.

At 1545, the method may include transmitting the feedback report to the base station. The operations of 1545 may be performed in accordance with examples as disclosed herein. In some examples, aspects of the operations of 1545 may be performed by a transmitting component 840 as described with reference to FIG. 8.

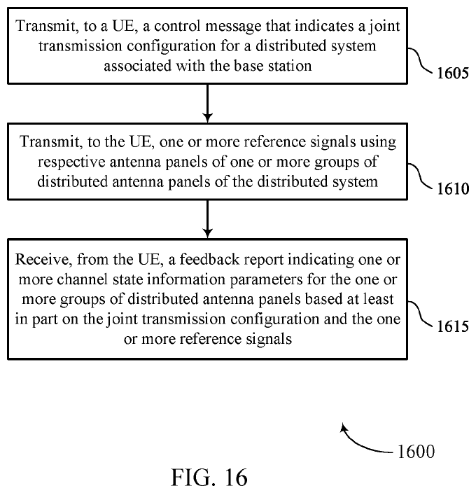

FIG. 16 shows a flowchart illustrating a method 1600 that supports channel measurement and reporting in distributed wireless systems in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, a control message that indicates a joint transmission configuration for a distributed system associated with the base station. The operations of 1605 may be performed in accordance with examples as disclosed herein. In some examples, aspects of the operations of 1605 may be performed by a control message transmitting component 1225 as described with reference to FIG. 12.

At 1610, the method may include transmitting, to the UE, one or more reference signals using respective antenna panels of one or more groups of distributed antenna panels of the distributed system. The operations of 1610 may be performed in accordance with examples as disclosed herein. In some examples, aspects of the operations of 1610 may be performed by a reference signal transmitting component 1230 as described with reference to FIG. 12.

At 1615, the method may include receiving, from the UE, a feedback report indicating one or more CSI parameters for the one or more groups of distributed antenna panels based on the joint transmission configuration and the one or more reference signals. The operations of 1615 may be performed in accordance with examples as disclosed herein. In some examples, aspects of the operations of 1615 may be performed by a report receiving component 1235 as described with reference to FIG. 12.

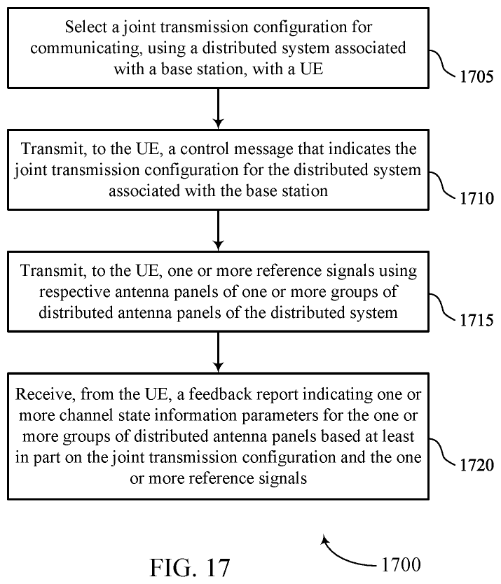

FIG. 17 shows a flowchart illustrating a method 1700 that supports channel measurement and reporting in distributed wireless systems in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include selecting a joint transmission configuration for communicating, using a distributed system associated with a base station, with a UE. The operations of 1705 may be performed in accordance with examples as disclosed herein. In some examples, aspects of the operations of 1705 may be performed by a selecting component 1240 as described with reference to FIG. 12.

At 1710, the method may include transmitting, to the UE, a control message that indicates the joint transmission configuration for the distributed system associated with the base station. The operations of 1710 may be performed in accordance with examples as disclosed herein. In some examples, aspects of the operations of 1710 may be performed by a control message transmitting component 1225 as described with reference to FIG. 12.

At 1715, the method may include transmitting, to the UE, one or more reference signals using respective antenna panels of one or more groups of distributed antenna panels of the distributed system. The operations of 1715 may be performed in accordance with examples as disclosed herein. In some examples, aspects of the operations of 1715 may be performed by a reference signal transmitting component 1230 as described with reference to FIG. 12.

At 1720, the method may include receiving, from the UE, a feedback report indicating one or more CSI parameters for the one or more groups of distributed antenna panels based on the joint transmission configuration and the one or more reference signals. The operations of 1720 may be performed in accordance with examples as disclosed herein. In some examples, aspects of the operations of 1720 may be performed by a report receiving component 1235 as described with reference to FIG. 12.

The following provides an overview of aspects of the present disclosure:

Aspect 1: A method for wireless communications at a UE, comprising: receiving, from a base station, a control message that indicates a joint transmission configuration for a distributed system associated with the base station; receiving one or more reference signals from respective antenna panels of one or more groups of distributed antenna panels of the distributed system; generating a feedback report indicating one or more CSI parameters for the one or more groups of distributed antenna panels based at least in part on the joint transmission configuration and the one or more reference signals; and transmitting the feedback report to the base station.

Aspect 2: The method of aspect 1, wherein receiving the one or more reference signals comprises: receiving a first CSI-RS via a first set of resources from a first group of antenna panels of the one or more groups of distributed antenna panels; and receiving a second CSI-RS via a second set of resources from a second group of antenna panels of the one or more groups of distributed antenna panels.

Aspect 3: The method of aspect 2, wherein generating the feedback report comprises: generating a first CSI parameter for the first group of antenna panels based at least in part on the first CSI-RS; and generating a second CSI parameter for the second group of antenna panels based at least in part on the second CSI-RS, wherein the feedback report comprises the first and second CSI parameters according to a reporting order that is based at least in part on the first and second sets of resources.

Aspect 4: The method of aspect 3, further comprising: receiving an indication of the reporting order from the base station, the reporting order configured for the UE.

Aspect 5: The method of any of aspects 3 through 4, wherein the reporting order corresponds to an increasing order or a decreasing order of respective resource identifiers for the first and second sets of resources.

Aspect 6: The method of any of aspects 1 through 5, wherein generating the feedback report comprises: generating one or more co-phasing coefficients for the feedback report based at least in part on the joint transmission configuration indicating a fully coherent configuration or a partially coherent configuration, the one or more co-phasing coefficients for the one or more groups of distributed antenna panels.

Aspect 7: The method of any of aspects 1 through 6, wherein generating the feedback report comprises: generating one or more CRIs, each of the one or more CRIs corresponding to a respective group of the one or more groups of the distributed antenna panels of the distributed system.

Aspect 8: The method of aspect 7, further comprising: separately encoding each CRI for each group of the one or more groups of the distributed antenna panels of the distributed system, wherein the feedback report includes the separately encoded CRI for each group.

Aspect 9: The method of any of aspects 7 through 8, further comprising: jointly encoding the one or more CRIs for the one or more groups of the distributed antenna panels of the distributed system, wherein the feedback report includes the jointly encoded one or more CRIs.

Aspect 10: The method of any of aspects 1 through 9, wherein generating the feedback report comprises: generating one or more co-phasing coefficients for the feedback report, each of the one or more co-phasing coefficients corresponding to a respective group of the one or more groups of the distributed antenna panels of the distributed system, wherein at least one of the one or more co-phasing coefficients is zero based at least in part on the joint transmission configuration being a partially coherent configuration.

Aspect 11: The method of any of aspects 1 through 10, wherein generating the feedback report comprises: generating one or more co-phasing coefficients for the feedback report, each of the one or more co-phasing coefficients corresponding to a respective group of the one or more groups of the distributed antenna panels of the distributed system, each group associated with a respective layer of a joint transmission for the UE, wherein at least one of the one or more co-phasing coefficients is zero based at least in part on the joint transmission configuration being a non-coherent configuration.

Aspect 12: The method of any of aspects 1 through 11, wherein generating the feedback report comprises: generating a precoder matrix for the feedback report based at least in part on the joint transmission configuration being a fully coherent configuration, wherein each column of the precoder matrix includes at least one non-zero value, the precoder matrix corresponding to a group of the one or more groups of the distributed antenna panels of the distributed system.

Aspect 13: The method of any of aspects 1 through 12, wherein the joint transmission configuration comprises one of a fully coherent configuration, a partially coherent configuration, or a non-coherent configuration.

Aspect 14: The method of any of aspects 1 through 13, wherein receiving the control message comprises: receiving the control message via RRC signaling, a MAC-CE, or DCI.

Aspect 15: A method for wireless communications at a base station, comprising: transmitting, to a UE, a control message that indicates a joint transmission configuration for a distributed system associated with the base station; transmitting, to the UE, one or more reference signals using respective antenna panels of one or more groups of distributed antenna panels of the distributed system; and receiving, from the UE, a feedback report indicating one or more CSI parameters for the one or more groups of distributed antenna panels based at least in part on the joint transmission configuration and the one or more reference signals.

Aspect 16: The method of aspect 15, wherein transmitting the one or more reference signals comprises: transmitting a first CSI-RS via a first set of resources using a first group of antenna panels of the one or more groups of distributed antenna panels; and transmitting a second CSI-RS via a second set of resources using a second group of antenna panels of the one or more groups of distributed antenna panels.

Aspect 17: The method of aspect 16, wherein receiving the feedback report comprises: receiving a first CSI parameter for the first group of antenna panels based at least in part on the first CSI-RS; and receiving a second CSI parameter for the second group of antenna panels based at least in part on the second CSI-RS, wherein the feedback report comprises the first and second CSI parameters according to a reporting order that is based at least in part on the first and second sets of resources.

Aspect 18: The method of aspect 17, further comprising: transmitting an indication of the reporting order, the reporting order configured for the UE.

Aspect 19: The method of any of aspects 17 through 18, wherein the reporting order corresponds to an increasing order or a decreasing order of respective resource identifiers for the first and second sets of resources.

Aspect 20: The method of any of aspects 15 through 19, wherein receiving the feedback report comprises: receiving one or more co-phasing coefficients in the feedback report based at least in part on the joint transmission configuration indicating a fully coherent configuration or a partially coherent configuration, the one or more co-phasing coefficients for the one or more groups of distributed antenna panels.

Aspect 21: The method of any of aspects 15 through 20, wherein receiving the feedback report comprises: receiving one or more CRIs, each of the one or more CRIs corresponding to a respective group of the one or more groups of the distributed antenna panels of the distributed system.

Aspect 22: The method of aspect 21, wherein the feedback report includes the separately encoded CRI for each group.

Aspect 23: The method of any of aspects 21 through 22, wherein the feedback report includes the jointly encoded one or more CRIs.

Aspect 24: The method of any of aspects 15 through 23, wherein receiving the feedback report comprises: receiving one or more co-phasing coefficients in the feedback report, each of the one or more co-phasing coefficients corresponding to a respective group of the one or more groups of the distributed antenna panels of the distributed system, wherein at least one of the one or more co-phasing coefficients is zero based at least in part on the joint transmission configuration being a partially coherent configuration.

Aspect 25: The method of any of aspects 15 through 24, wherein receiving the feedback report comprises: receiving one or more co-phasing coefficients in the feedback report, each of the one or more co-phasing coefficients corresponding to a respective group of the one or more groups of the distributed antenna panels of the distributed system, each group associated with a respective layer of a joint transmission for the UE, wherein at least one of the one or more co-phasing coefficients is zero based at least in part on the joint transmission configuration being a non-coherent configuration.

Aspect 26: The method of any of aspects 15 through 25, wherein receiving the feedback report comprises: receiving a precoder matrix in the feedback report based at least in part on the joint transmission configuration being a fully coherent configuration, wherein each column of the precoder matrix includes at least one non-zero value, the precoder matrix corresponding to a group of the one or more groups of the distributed antenna panels of the distributed system.

Aspect 27: The method of any of aspects 15 through 26, further comprising: selecting the joint transmission configuration for communicating, using the distributed system associated with the base station, with the UE.

Aspect 28: The method of any of aspects 15 through 27, wherein the joint transmission configuration comprises one of a fully coherent configuration, a partially coherent configuration, or a non-coherent configuration.

Aspect 29: An apparatus for wireless communications at a UE, comprising a processor; memory coupled with the processor; and instructions stored in the memory and executable by the processor to cause the apparatus to perform a method of any of aspects 1 through 14.

Aspect 30: An apparatus for wireless communications at a UE, comprising at least one means for performing a method of any of aspects 1 through 14.

Aspect 31: A non-transitory computer-readable medium storing code for wireless communications at a UE, the code comprising instructions executable by a processor to perform a method of any of aspects 1 through 14.

Aspect 32: An apparatus for wireless communications at a base station, comprising a processor; memory coupled with the processor; and instructions stored in the memory and executable by the processor to cause the apparatus to perform a method of any of aspects 15 through 28.

Aspect 33: An apparatus for wireless communications at a base station, comprising at least one means for performing a method of any of aspects 15 through 28.

Aspect 34: A non-transitory computer-readable medium storing code for wireless communications at a base station, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a base station, a control message that indicates a joint transmission configuration for a distributed system associated with the base station;
receive one or more reference signals from respective antenna panels of one or more groups of distributed antenna panels of the distributed 11 system;
generate a feedback report indicating one or more channel state information parameters for the one or more groups of distributed antenna panels based at least in part on the joint transmission configuration and the one or more reference signals; and
transmit the feedback report to the base station.

2. The apparatus of claim 1, wherein the instructions to receive the one or more reference signals are executable by the processor to cause the apparatus to:
receive a first channel state information reference signal via a first set of resources from a first group of antenna panels of the one or more groups of distributed antenna panels; and
receive a second channel state information reference signal via a second set of resources from a second group of antenna panels of the one or more groups of distributed antenna panels.

3. The apparatus of claim 2, wherein the instructions to generate the feedback report are executable by the processor to cause the apparatus to:
generate a first channel state information parameter for the first group of antenna panels based at least in part on the first channel state information reference signal; and
generate a second channel state information parameter for the second group of antenna panels based at least in part on the second channel state information reference signal, wherein the feedback report comprises the first and second channel state information parameters according to a reporting order that is based at least in part on the first and second sets of resources.

4. The apparatus of claim 3, wherein the instructions are further executable by the processor to cause the apparatus to:
receive an indication of the reporting order from the base station, the reporting order configured for the UE.

5. The apparatus of claim 3, wherein the reporting order corresponds to an increasing order or a decreasing order of respective resource identifiers for the first and second sets of resources.

6. The apparatus of claim 1, wherein the instructions to generate the feedback report are executable by the processor to cause the apparatus to:
generate one or more co-phasing coefficients for the feedback report based at least in part on the joint transmission configuration indicating a fully coherent configuration or a partially coherent configuration, the one or more co-phasing coefficients for the one or more groups of distributed antenna panels.

7. The apparatus of claim 1, wherein the instructions to generate the feedback report are executable by the processor to cause the apparatus to:
generate one or more channel state information reference signal resource indicators, each of the one or more channel state information reference signal resource indicators corresponding to a respective group of the one or more groups of the distributed antenna panels of the distributed system.

8. The apparatus of claim 7, wherein the instructions are further executable by the processor to cause the apparatus to:
separately encode each channel state information reference signal resource indicator for each group of the one or more groups of the distributed antenna panels of the distributed system, wherein the feedback report includes the separately encoded channel state information reference signal resource indicator for each group.

9. The apparatus of claim 7, wherein the instructions are further executable by the processor to cause the apparatus to:
jointly encode the one or more channel state information reference signal resource indicators for the one or more groups of the distributed antenna panels of the distributed system, wherein the feedback report includes the jointly encoded one or more channel state information reference signal resource indicators.

10. The apparatus of claim 1, wherein the instructions to generate the feedback report are executable by the processor to cause the apparatus to:
generate one or more co-phasing coefficients for the feedback report, each of the one or more co-phasing coefficients corresponding to a respective group of the one or more groups of the distributed antenna panels of the distributed system, wherein at least one of the one or more co-phasing coefficients is zero based at least in part on the joint transmission configuration being a partially coherent configuration.

11. The apparatus of claim 1, wherein the instructions to generate the feedback report are executable by the processor to cause the apparatus to:
generate one or more co-phasing coefficients for the feedback report, each of the one or more co-phasing coefficients corresponding to a respective group of the one or more groups of the distributed antenna panels of the distributed system, each group associated with a respective layer of a joint transmission for the UE, wherein at least one of the one or more co-phasing coefficients is zero based at least in part on the joint transmission configuration being a non-coherent configuration.

12. The apparatus of claim 1, wherein the instructions to generate the feedback report are executable by the processor to cause the apparatus to:
generate a precoder matrix for the feedback report based at least in part on the joint transmission configuration being a fully coherent configuration, wherein each column of the precoder matrix includes at least one non-zero value, the precoder matrix corresponding to a group of the one or more groups of the distributed antenna panels of the distributed system.

13. The apparatus of claim 1, wherein the joint transmission configuration comprises one of a fully coherent configuration, a partially coherent configuration, or a non-coherent configuration.

14. The apparatus of claim 1, wherein the instructions to receive the control message are executable by the processor to cause the apparatus to:
receive the control message via radio resource control (RRC) signaling, a medium access control (MAC) control element (MAC-CE), or downlink control information (DCI).

15. An apparatus for wireless communications at a base station, comprising:
a processor;
memory coupled with the processor; and
instructions stored in the memory and executable by the processor to cause the apparatus to:
transmit, to a user equipment (UE), a control message that indicates a joint transmission configuration for a distributed system associated with the base station;
transmit, to the UE, one or more reference signals using respective antenna panels of one or more groups of distributed antenna panels of the distributed system; and
receive, from the UE, a feedback report indicating one or more channel state information parameters for the one or more groups of distributed antenna panels based at least in part on the joint transmission configuration and the one or more reference signals.

16. The apparatus of claim 15, wherein the instructions to transmit the one or more reference signals are executable by the processor to cause the apparatus to:
transmit a first channel state information reference signal via a first set of resources using a first group of antenna panels of the one or more groups of distributed antenna panels; and
transmit a second channel state information reference signal via a second set of resources using a second group of antenna panels of the one or more groups of distributed antenna panels.

17. The apparatus of claim 16, wherein the instructions to receive the feedback report are executable by the processor to cause the apparatus to:
receive a first channel state information parameter for the first group of antenna panels based at least in part on the first channel state information reference signal; and
receive a second channel state information parameter for the second group of antenna panels based at least in part on the second channel state information reference signal, wherein the feedback report comprises the first and second channel state information parameters according to a reporting order that is based at least in part on the first and second sets of resources.

18. The apparatus of claim 17, wherein the instructions are further executable by the processor to cause the apparatus to:
transmit an indication of the reporting order, the reporting order configured for the UE.

19. The apparatus of claim 17, wherein the reporting order corresponds to an increasing order or a decreasing order of respective resource identifiers for the first and second sets of resources.

20. The apparatus of claim 15, wherein the instructions to receive the feedback report are executable by the processor to cause the apparatus to:
receive one or more co-phasing coefficients in the feedback report based at least in part on the joint transmission configuration indicating a fully coherent configuration or a partially coherent configuration, the one or more co-phasing coefficients for the one or more groups of distributed antenna panels.

21. The apparatus of claim 15, wherein the instructions to receive the feedback report are executable by the processor to cause the apparatus to:
receive one or more channel state information reference signal resource indicators, each of the one or more channel state information reference signal resource indicators corresponding to a respective group of the one or more groups of the distributed antenna panels of the distributed system.

22. The apparatus of claim 21, wherein the feedback report includes the separately encoded channel state information reference signal resource indicator for each group.

23. The apparatus of claim 21, wherein the feedback report includes the jointly encoded one or more channel state information reference signal resource indicators.

24. The apparatus of claim 15, wherein the instructions to receive the feedback report are executable by the processor to cause the apparatus to:
receive one or more co-phasing coefficients in the feedback report, each of the one or more co-phasing coefficients corresponding to a respective group of the one or more groups of the distributed antenna panels of the distributed system, wherein at least one of the one or more co-phasing coefficients is zero based at least in part on the joint transmission configuration being a partially coherent configuration.

25. The apparatus of claim 15, wherein the instructions to receive the feedback report are executable by the processor to cause the apparatus to:
receive one or more co-phasing coefficients in the feedback report, each of the one or more co-phasing coefficients corresponding to a respective group of the one or more groups of the distributed antenna panels of the distributed system, each group associated with a respective layer of a joint transmission for the UE, wherein at least one of the one or more co-phasing coefficients is zero based at least in part on the joint transmission configuration being a non-coherent configuration.

26. The apparatus of claim 15, wherein the instructions to receive the feedback report are executable by the processor to cause the apparatus to:
receive a precoder matrix in the feedback report based at least in part on the joint transmission configuration being a fully coherent configuration, wherein each column of the precoder matrix includes at least one non-zero value, the precoder matrix corresponding to a group of the one or more groups of the distributed antenna panels of the distributed system.

27. The apparatus of claim 15, wherein the instructions are further executable by the processor to cause the apparatus to:
select the joint transmission configuration for communicating, using the distributed system associated with the base station, with the UE.

28. The apparatus of claim 15, wherein the joint transmission configuration comprises one of a fully coherent configuration, a partially coherent configuration, or a non-coherent configuration.

29. A method for wireless communications at a user equipment (UE), comprising:
receiving, from a base station, a control message that indicates a joint transmission configuration for a distributed system associated with the base station;
receiving one or more reference signals from respective antenna panels of one or more groups of distributed antenna panels of the distributed system;
generating a feedback report indicating one or more channel state information parameters for the one or more groups of distributed antenna panels based at least in part on the joint transmission configuration and the one or more reference signals; and
transmitting the feedback report to the base station.

30. A method for wireless communications at a base station, comprising:
transmitting, to a user equipment (UE), a control message that indicates a joint transmission configuration for a distributed system associated with the base station;
transmitting, to the UE, one or more reference signals using respective antenna panels of one or more groups of distributed antenna panels of the distributed system; and
receiving, from the UE, a feedback report indicating one or more channel state information parameters for the one or more groups of distributed antenna panels based at least in part on the joint transmission configuration and the one or more reference signals.
